(19) United States
(12) Patent Application Publication
(10) Pub. No.: US 2011/0304864 A1
(43) Pub. Date: Dec. 15, 2011

(54) SYSTEM, APPARATUS, AND METHOD FOR CONTROLLING USE OF FUNCTION OF IMAGE PROCESSING APPARATUS

(75) Inventor: Toru AKUTSU, Kanagawa (JP)

(73) Assignee: RICOH COMPANY, LTD.

(21) Appl. No.: 13/116,985

(22) Filed: May 26, 2011

(30) Foreign Application Priority Data
Jun. 10, 2010 (JP) 2010-132936

(51) Int. Cl. G06F 15/00

(52) U.S. Cl. 358/1.9; 358/1.15

(57) ABSTRACT

An image processing apparatus includes a control data storage part configured to store control data including plural control settings that limit execution of a function of the image processing apparatus, the plural control settings including execution conditions that are progressively set in correspondence with one or more processes performed by the function of the image processing apparatus, an application control determination part configured to determine one or more of the plural control settings to be applied to the function, and a function process control part configured to limit the execution of the function by applying the one or more of the plural control settings to the function in correspondence with the progressively set execution conditions.

### BACKGROUND OF THE INVENTION

1. Field of the Invention

The present invention relates to a system, an apparatus, and a method for controlling the use of an image processing apparatus.

2. Description of the Related Art

A function of controlling an upper limit of the number of printable sheets of paper (hereinafter also referred to as “upper limit managing function”) is known as one of the printing functions of an image forming apparatus.

With the upper limit managing function, in a case where the number of printed sheets reaches a predetermined upper limit, the image forming apparatus is controlled so that, the image forming apparatus stops printing and notifies the user that the number of printed sheets has reached the predetermined upper limit. As a result, printing costs and consumption resources can be reduced. Because the printing functions of the image forming apparatus is used in various situations, the upper limit managing function may sometimes cause inconvenience for the user depending on the situation in which the image forming apparatus is used.

Accordingly, for the purpose of providing user-friendly printing, a related art example, (e.g., Japanese Laid-Open Patent Publication No. 11-85419) discloses a technology that enables a printer system to appropriately perform processes even in a case where the number of printed sheets has reached an upper limit.

However, with the technology disclosed in the related art example, the user is unable to know the upper limit on a step-by-step basis. That is, the user cannot know whether the upper limit is reached until the user obtains a result according to a printing proceeding method. For example, the user may not know that the upper limit is reached until receiving a printing result indicating that the printing mode has been changed.

Initially, the upper limit managing function is for allowing an administrator to prevent unnecessary use of a printing function by the users. However, the upper limit managing function is not to cause inconvenience to the user. In view of these aspects, it is preferred that the upper limit managing function be controlled step-by-step.

### SUMMARY OF THE INVENTION

The present invention may provide a system, an apparatus, and a method for controlling the use of an image processing apparatus that substantially eliminate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a system, an apparatus, and a method for controlling the use of an image processing apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an image processing apparatus including: a control data storage part configured to store control data including plural control settings that limit execution of a function of the image processing apparatus, the plural control settings including execution conditions that are progressively set in correspondence with one or more processes performed by the function of the image processing apparatus; an application control determination part configured to determine one or more of the plural control settings to be applied to the function; and a function process control part configured to limit the execution of the function by applying the one or more of the plural control settings to the function in correspondence with the progressively set execution conditions.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating a hardware configuration of an image processing apparatus according to a first embodiment of the present invention;

FIG. 2 is a schematic diagram illustrating a configuration of a CPU for performing a function use limitation process according to an embodiment of the present invention;

FIG. 3 is a schematic diagram illustrating an example of a setting screen for setting an upper limit use value data according to an embodiment of the present invention;

FIG. 4 is a schematic diagram illustrating an example of a setting screen for setting conditions (control rules) for executing use limitation according to an embodiment of the present invention;

FIG. 5 is a schematic diagram illustrating an example of a data structure of a control data according to an embodiment of the present invention;

FIG. 6 illustrates an example of a data structure of an accumulated use amount data according to an embodiment of the present invention;

FIG. 7A is a flowchart illustrating an example of a function use control operation according to an embodiment of the present invention;

FIG. 7B is a flowchart illustrating an example of an accumulated use amount value recording operation according to an embodiment of the present invention;

FIG. 8 is a schematic diagram illustrating an example of a setting screen for setting control levels corresponding to control settings used in performing a function use limitation process according to an embodiment of the present invention;

FIG. 9 is a schematic diagram illustrating an example of a setting screen for setting use limitation contents when an accumulated use amount reaches an upper limit use value according to an embodiment of the present invention;

FIG. 10 is a schematic diagram illustrating another example of a setting screen for setting conditions (control rules) for executing use limitation according to an embodiment of the present invention;

FIG. 11 is a schematic diagram illustrating an example of a data structure of control data according to another embodiment of the present invention;

FIGS. 12A and 12B are flowcharts for describing another example of a process for controlling the use of a function of an image processing apparatus according to an embodiment of the present invention;

FIG. 13 is a schematic diagram illustrating a configuration of a function use control system according to an embodiment of the present invention;

FIG. 14 is a schematic diagram illustrating a configuration of hardware parts of an authentication management apparatus according to an embodiment of the present invention;

FIG. 15 is a schematic diagram illustrating function parts of a function use control system according to an embodiment of the present invention;

FIGS. 16A and 16B illustrate examples of data structures of user data according to an embodiment of the present invention;

FIGS. 17A and 17B illustrate examples of data structures of upper limit use value data according to an embodiment of the present invention;

FIGS. 18A and 18B illustrate examples of data structures of control data according to an embodiment of the present invention;

FIGS. 19A and 19B illustrate examples of data structures of accumulated use amount data according to an embodiment of the present invention;

FIGS. 20A, 20B, and 20C are flowcharts for describing an example of a process for controlling the use of a function of an image processing apparatus according to the second embodiment of the present invention;

FIG. 21 is a schematic diagram illustrating a configuration of a function use control system according to a first modified example; and

FIG. 22 is a schematic diagram illustrating a configuration of the function use control system 1 according to a second modified example

### DETAILED DESCRIPTION OF THE PREFERRED EMBODIMENTS

### First Embodiment

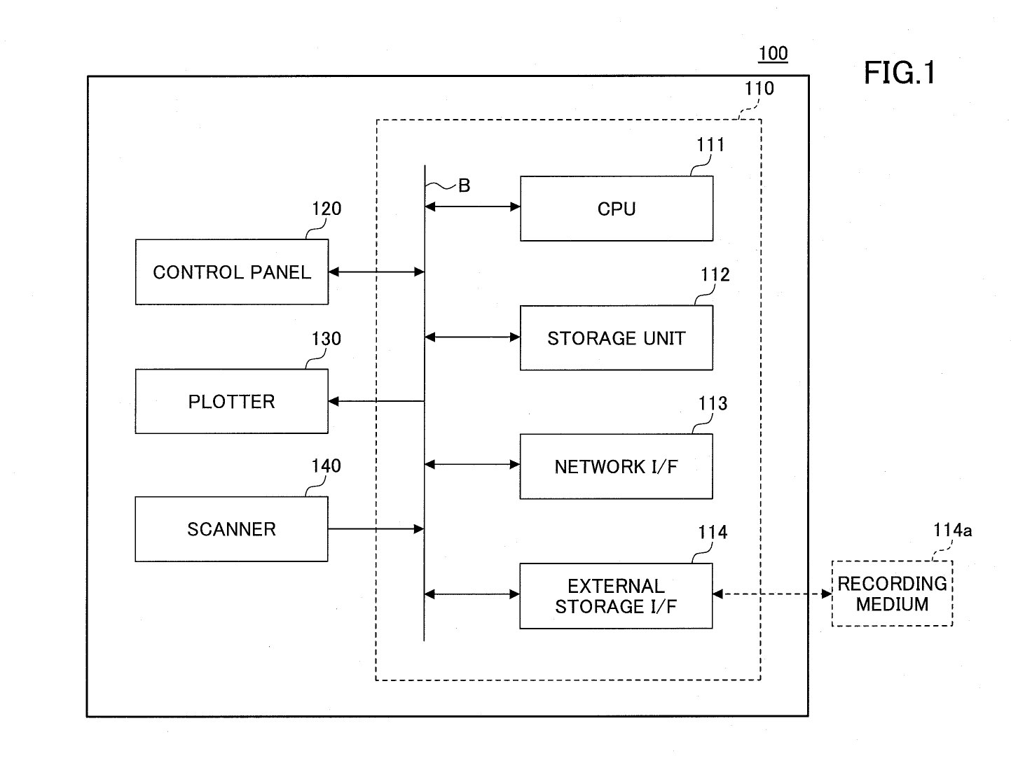

FIG. 1 is a schematic diagram illustrating a hardware configuration of an image processing apparatus 100 according to the first embodiment. As illustrated in FIG. 1, the image processing apparatus 100 includes, for example, a controller 110, a control panel 120, a plotter 130, and a scanner 140 that are connected by a bus B.

The control panel 120 includes a display part and an input part. The control panel 120 is for providing various information (e.g., machine information) and receiving various operations (e.g., setting of processes, instructing of operations) by the user. The plotter 130 includes an image forming part. The plotter 130 is for forming output images on sheets of paper. For example, an electrophotographic process or an inkjet process may be used as the method for outputting images with the plotter 130. The scanner 140 is for optically reading images from an original document and generating the read out images.

The controller 110 includes, for example, a CPU (Central Processing Unit) 111, a storage unit 112, a network I/F (interface) 113, and an external storage I/F (interface) 114 that are connected by the bus B.

The CPU 111 controls the entire image processing apparatus 100 by executing programs. The storage unit 112 stores and retains the programs executed by the CPU and various data (e.g., image data). The storage unit 112 may include, for example, a volatile memory such as a RAM (Random Access Memory), a non-volatile memory such as a ROM (Read Only Memory), and a device having a large storage space such as a HOD (Hard Disk Drive). The RAM functions as a work area (temporary storage data in which read out programs and data are temporarily stored) of the CPU 111. The ROM and the HDD is used for storing programs and various data. Accordingly, the CPU 111, for example, loads a program stored in the ROM to the RAM and executes the program.

The network I/F 113 acts as an interface for connecting the image processing apparatus 100 to a predetermined data path N such as a network (e.g., LAN (Local Area Network)). Accordingly, the image processing apparatus 100 can perform data communications with an external device including a communication part.

The external storage I/F 114 acts as an interface for connecting the image processing apparatus 100 with an external storage device such as a recording medium 114a. Accordingly, the image processing apparatus 100 can read out and/or write data from/to the recording medium 114a via the external storage I/F 114. The recording medium 14a may be, for example, an SD (Secure Digital) memory card.

Hence, the image processing apparatus 100 can provide various image processing services (image processing functions) by using the above-described hardware configuration.

### <Use Control Function>

A use control function according to an embodiment of the present invention is described.

The image processing apparatus 100 includes a use limiting function that limits the use of a function (use limitation) of the image processing apparatus 100 in a step-by-step manner. In the image processing apparatus 100, upper limit use value data, accumulated use amount data, and control data are stored in predetermined storage areas. The upper limit use value data indicates a value of an upper limit for using a function (upper limit use value). The accumulated use amount data indicates a value of the amount of use accumulated by executing the function based on calculation from the use history of the function (accumulated use amount). The control data includes various data of settings (control settings) used for performing use limitation in a step by step manner according to the upper limit use value data and the accumulated use amount data. In a case where the image processing apparatus 100 receives a request for executing a process with a corresponding function (execution request), the image processing apparatus 100 determines whether one or more control settings corresponding to the received execution request exist. Then, in a case where the image processing apparatus 100 determines that one or more control settings corresponding to the received execution request is stored in the image processing apparatus, the image processing apparatus 100 selects a control setting to be applied to the function of the image processing apparatus when executing the requested process from the corresponding one or more control settings based on the upper limit use value and the accumulated value. The image processing apparatus 100 controls the use limitation of a function according to the content of a use limitation (use limitation content) included in the control setting selected by the image forming apparatus 100.

Accordingly, with the above-described embodiment of the image processing apparatus 100, the user can confirm the use limitation corresponding to the accumulated value and use a function to the fullest extent within the bounds of the use limitation. In other words, by using the use limitation function of the image processing apparatus 100 according to the above-described embodiment of the present invention, a function executing environment (platform) capable of flexibly responding progressively (step-by-step) in compliance with the user's need to use the functions of the image processing apparatus 100 and the administrator's needs to limit the use of the functions of the image processing apparatus 100.

Next, a configuration of a use limitation function and an operation of the use limitation function according to an embodiment of the present invention is described. Among the functions of the image processing apparatus 100, a printing function is described below as an example of a function subject to the use limitation function. It is, however, to be noted that the use limitation function can be applied to functions of the image processing apparatus 100 besides the printing function (e.g., document reading function). In a case where the image processing apparatus 100 is a multifunction machine, the printing function includes performing, for example, a process of a copier, a process of a printer, and a process of a facsimile machine. Therefore, in the below example, “total printed pages” indicates the total number of pages corresponding to each process performed with the printing function machine (e.g., total number of pages copied, total number of pages printed, total number of pages transmitted or received via facsimile communications).

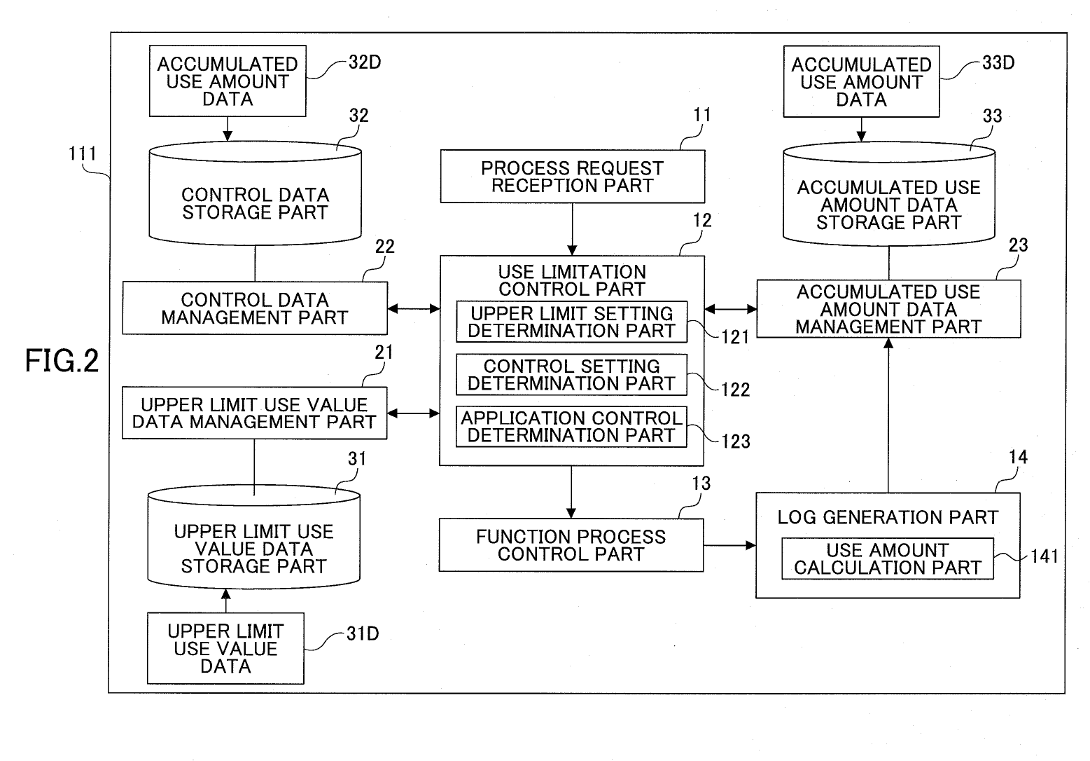

FIG. 2 is a schematic diagram illustrating a configuration of a CPU 111 for performing a function use limitation process according to an embodiment of the present invention. As illustrated in FIG. 2, the CPU 111 configured to perform the function use limitation operation includes, for example, a process request reception part 11, a use limitation control part 12, a function process control part 13, a log generation part 14, and various data management parts 21, 22, 23.

The process request reception part 11 is for receiving a request for executing a process with a corresponding function (execution request). The process request reception part 11 receives an event report when execution of the process is requested and obtains data indicating the content of the requested process from the event report. Then, the process request reception part 11 sends the obtained data to the use limitation control part 12.

The use limitation control part 12 is for controlling the application of a use limitation of the function corresponding to the requested process. The use limitation control part 12 selects (determines) the control setting to be applied when performing the function corresponding to the requested process from the plural control settings contained in the control data for progressively limiting the function of the image processing apparatus 100 (i.e. performing use limitation in a step by step manner) by using the upper limit use value and the accumulated value. Based on the use limitation content of the selected use control setting, the use limitation control part 12 instructs the function process control part 13 to apply the use limitation of the selected use control setting to the function and execute the function having the use limitation applied thereto.

Accordingly, the image processing apparatus 100 according to the above-described embodiment includes function parts for managing various kinds of data including the upper limit use value data, the accumulated use amount data, and the control setting data which are to be used by the use limitation control part 12.

Next, examples of the function parts of the image processing apparatus 100 are described.

An upper limit use value data management part 21 is a function part that manages the upper limit use value (upper limit use value data). The use limit data storage part 21 manages the upper limit use value data stored in an upper limit use value data storage part 31 by accessing the upper limit use value data storage part 31 and manipulating (processing) the upper limit use value data in accordance with instructions from, for example, the user of the image processing apparatus 100 via the use limitation control part 12. The upper limit use value data storage part 31 may be, for example, a storage device (e.g., HDD (Hard Disk Drive)) of the image processing apparatus 100 having a predetermined storage space. The manipulating (processing) of the upper limit use value data includes, for example, storing of data (e.g., registering, updating), erasing (deleting) of data, obtaining (acquiring) of data, and/or referring (searching) of data.

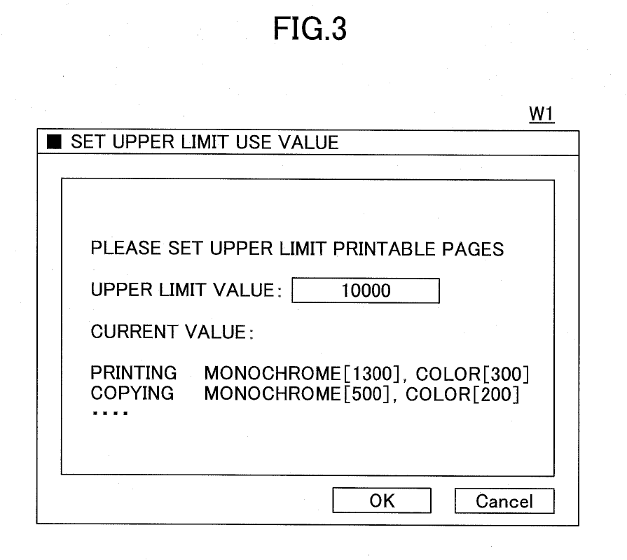

As illustrated in FIG. 3, the upper limit use value data management part 21 provides (displays) an environment for setting the upper limit use value data (indicated with reference numeral 31D in FIG. 2) in a setting screen W1. FIG. 3 is a schematic diagram illustrating an example of the setting screen W1 for setting the upper limit use value data 31D (in this embodiment, upper limit printable pages) according to an embodiment of the present invention. For example, in a case of setting the upper limit use value data 31D with the setting screen W1 illustrated in FIG. 3, the user can confirm the accumulated use amount of the printing function and set the upper limit use value data 31D (i.e. upper limit printable pages) based on the confirmed accumulated use amount. For example, the user of the image processing apparatus 100 can instruct the setting of the upper limit use value data 310 by inputting the upper limit printable pages in a corresponding text box indicated in the setting screen W1. When an “OK” button on the setting screen W1 is pressed, the upper limit use value data management part 21 stores (registers) the input value as the upper limit use value data 31D in the upper limit use value storage part 31 in accordance with the settings instructed by the user.

Accordingly, the use limitation control part 12 can obtain the upper limit use value data 31D set by the user by instructing the upper limit use value management part 21 to refer to the upper limit use value storage part 31.

A control data management part 22 is a function part that manages data indicating conditions (control rules) for executing use limitation. The data indicating the conditions for executing use limitation may be referred to as control settings. The control data management part 22 manages control data stored in a control data storage part 32 by accessing the control data storage part 32 and manipulating (processing) the control data in accordance with instructions from, for example, the user of the image processing apparatus 100 via the use limitation control part 12. Similar to the upper limit use value data storage part 31, the control data storage part 32 may also be, for example, a storage device (e.g., HDD (Hard Disk Drive)) of the image processing apparatus 100 having a predetermined storage space. Likewise, the manipulating (processing) of the control data includes, for example, storing of data (e.g., registering, updating), erasing (deleting) of data, obtaining (acquiring) of data, and/or referring (searching) of data.

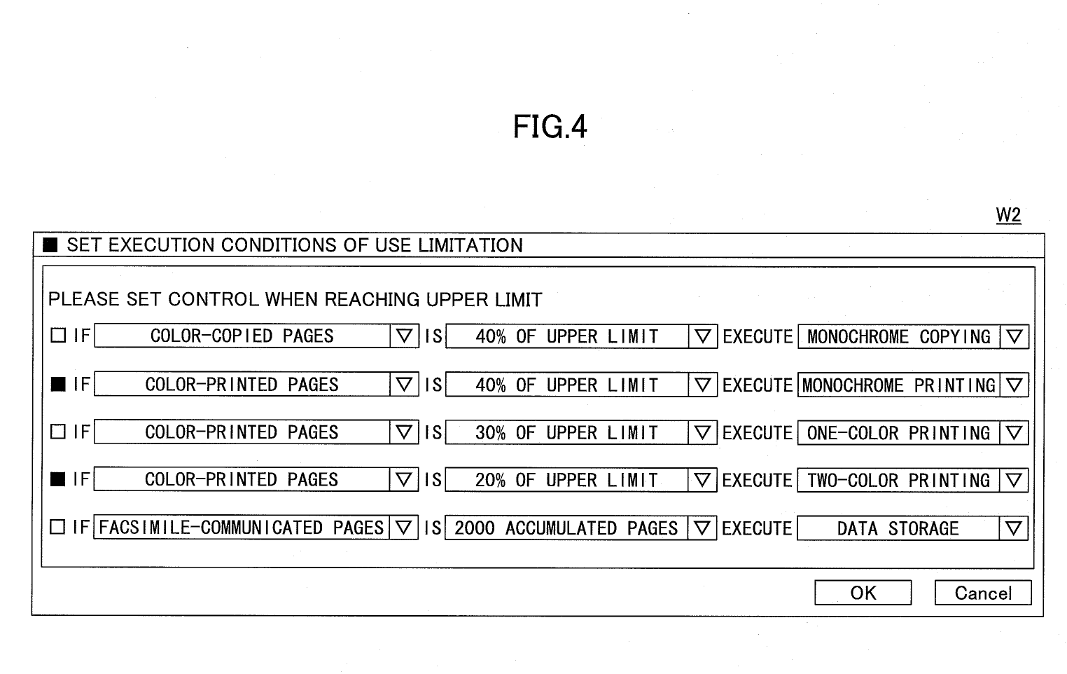

As illustrated in FIG. 4, the control data management part 22 provides (displays) an environment for setting the control data (indicated with reference numeral 32D in FIG. 2) in a setting screen W2. FIG. 4 is a schematic diagram illustrating an example of the setting screen W2 for setting the conditions (control rules) for executing use limitation (control data) according to an embodiment of the present invention. The setting screen W2 illustrated in FIG. 4 is for allowing, for example, the user to set the conditions for executing use limitation when an upper limit value is reached. The control data 32D that can be set with the setting screen W2 include, for example, data indicating: whether use limitation is valid/invalid according to selection from a check box (validity data); details (content) of a requested process (e.g., copying process, printing process, facsimile communication process) selected by combinations of pull-down menus (process content data); conditions for executing use limitation (use limitation execution conditions data) corresponding to the selected process content; and details of the use limitation (use limitation detail data). For example, “whether an accumulated number of printed pages has reached a predetermined proportion (percentage (%))” with respect to a predetermined upper limit printable pages may be set as a determination criterion (threshold) of the upper limit printable pages by using the setting screen W2.

By providing the setting environment (setting method by combining the use limitation execution conditions and the use limitation details with respect to each process) according to the above-described embodiment of the present invention, plural control settings corresponding to the process content (e.g., color copying, color printing, facsimile communication) can be set as setting data 32D with respect to the use limitation conditions progressively provided (provided step-by-step) for enabling, for example, a user to determine whether to limit the use of the functions (use limitation) of the image processing apparatus 100.

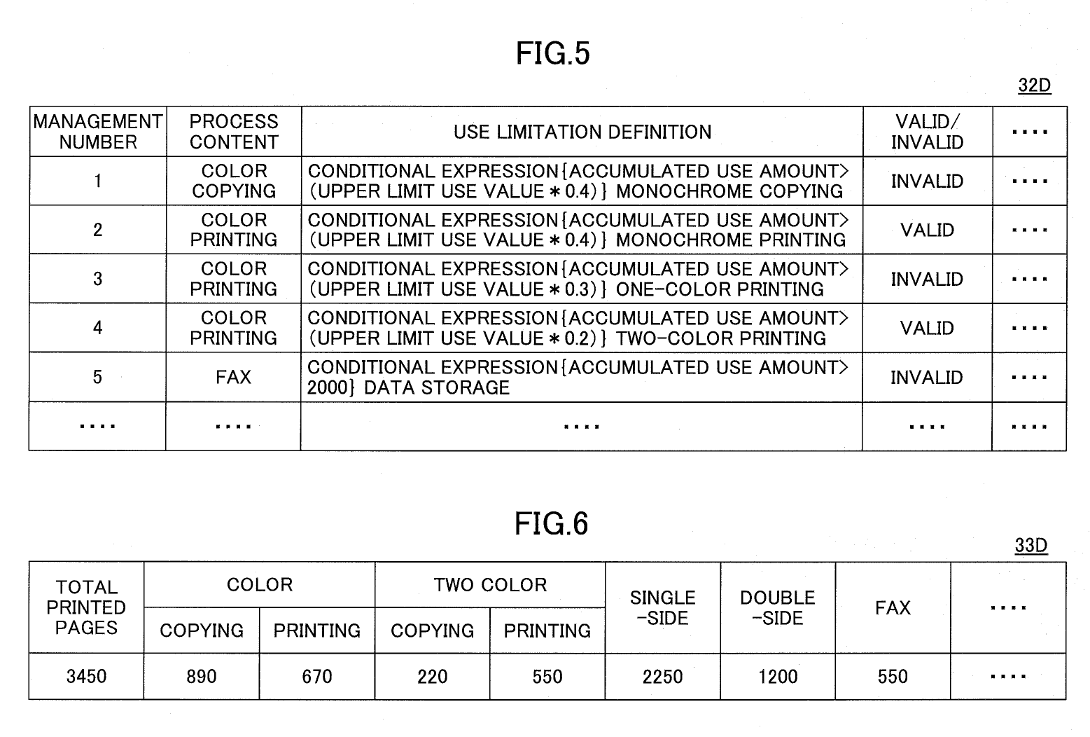

For example, the user of the image processing apparatus 100 can instruct the setting of the control data 32D by inputting (selecting) values corresponding to the use limitation execution conditions and the use limitation details with respect to each process indicated in the setting screen W2. When an “OK” button on the setting screen W2 is pressed, the control data management part 22 stores (registers) the input values as the control data 32D in the control data storage part 32 in accordance with the settings instructed by the user. As a result, the control data storage part 32 stores the input values as control data 32D having a data structure illustrated in FIG. 5.

FIG. 5 illustrates an example of the data structure of the control data 32D according to an embodiment of the present invention.

As illustrated in FIG. 5, the control data 32D include various items such as “management number”, “process content”, “use limitation definition”, and “valid/invalid”. Item values, which are assigned to the items of the control data 32D, correspond to registration controls.

The item “management number” represents data indicating a unique number corresponding to each registration control setting (registration management data). The item “process content” represents data that identifies the content (details) of a requested process (process content identification data). The item “use limitation definition” represents data that defines a use limitation (use limitation definition data). The item numbers include, for example, a conditional expression for comparison/determination between a threshold calculated by using an upper limit use value and an accumulated use amount (use limitation execution conditions) and use limitation details applied when a condition is satisfied. The threshold in this embodiment is a value calculated by, for example, the below-described application control determination part 123 in which the calculated value is obtained by multiplying a predetermined proportion with an upper limit use value. The predetermined proportion, which is progressively indicated (indicated in a step-by-step manner), represents the degree (phase) that the accumulated use amount has reached with respect to the upper limit use value. The item “valid/invalid” represents data indicating whether the registration control setting is valid or invalid (valid/invalid setting data). The control data management part 22 stores each item value in the control data 32D stored in the control data storage part 32. For example, in a case of receiving a value selected and input from the setting screen W2, the control data management part 22 stores the input value as an item value to a corresponding item of the control data 32D in the control data storage part 32.

Accordingly, the use limitation control part 12 can effectively set the controls corresponding to the process content by instructing the control data management part 22 to refer to the control data stored in the control data storage part 31.

The control data 32D of FIG. 5 illustrates an exemplary case where plural control settings are set to the item “process content” (in this case, “color printing”) of the management numbers 2, 3, and 4 in a step-by-step manner (phased manner) by using the setting screen W2 of FIG. 4. As for the control settings set to the management number 2, the use of the process “full color printing” is limited to “monochrome printing” in a case where the upper limit printable pages has reached 40% with respect to the accumulated printed pages. As for the control settings set to the management number 3, the use of the process “full color printing” is limited to “one-color printing” in a case where the upper limit printable pages has reached 30% with respect to the accumulated printed pages. As for the control settings set to the management number 4, the use of the process “full color printing” is limited to “two color printing” in a case where the upper limit printable pages has reached 20% with respect to the accumulated printed pages. Among the three control settings set to the management numbers 2, 3, and 4, the control settings of management numbers 2 and 4 are set to “valid”.

Accordingly, in a case where the process (process content) is “color printing (full color printing”, the conditions for executing use limitation (use limitation execution conditions) can be progressively set by setting the proportion of the accumulated printed pages with respect to the upper limit printable pages, to the control data 32D. Further, different use limitation contents (e.g., full color, two color, single color, monochrome) can be set in correspondence with each of the use limitation execution conditions. In other words, by using the control data 32D according to the above-described embodiment where the proportion of the accumulated use amount is smaller (lower level) with respect to the upper limit use value, control settings can be set within a limited range while being able to make the most use of the functions of the image processing apparatus 100.

An accumulated use amount data management part 23 is a function part that manages data indicating the accumulated use amount (accumulated use amount data). The accumulated use amount data management part 23 manages accumulated use amount data stored in an accumulated use amount data storage part 33 by accessing the accumulated use amount data storage part 33 and manipulating (processing) the accumulated use amount data in accordance with instructions from, for example, the user of the image processing apparatus 100 via the use limitation control part 12. Similar to the upper limit use value data storage part 31, the accumulated use amount data storage part 33 may also be, for example, a storage device (e.g., HDD (Hard Disk Drive)) of the image processing apparatus 100 having a predetermined storage space. Likewise, the manipulating (processing) of the accumulated use amount data includes, for example, storing of data (e.g., registering, updating), erasing (deleting) of data, obtaining (acquiring) of data, and/or referring (searching) of data.

The accumulated use amount data management part 23 calculates the accumulated use amount based on use history (log) of a function of the image processing apparatus 100 and stores the calculated accumulated use amount as accumulated use amount data 33D in the accumulated use amount data storage part 33. As a result, the use amount data storage part 33 stores the accumulated use amount data 33D that indicates the accumulated use amount in correspondence with the process content. For example, the accumulated use amount data 33D may have a data structure as illustrated in FIG. 6.

FIG. 6 illustrates an example of the data structure of the accumulated use amount data 33D according to an embodiment of the present invention. As illustrated in FIG. 6, the accumulated use amount data 33D include, for example, an item “total printed pages” and items corresponding to each process detail such as “color” (“copier”/“printer”)”, “two color (“copier”/“printer”)”, “single-side”, “double-side”, and “facsimile”. Thus, the total accumulated use amount (in this case, total printed pages) is a value indicating the total of the accumulated use amount of all of the process contents corresponding to the same function (in this example, printing function) of the image processing apparatus 100.

The item “color” represents data indicating the number of printed pages in a case where full-color printing is performed by using a copier or a printer (full-color printing page data). The item “two-color” represents data indicating the number of printed pages in a case where two-color printing is performed by using a copier or a printer (two-color printing page data). The item “single-side” represents data indicating the number of printed pages in a case where single-side printing is performed (single-side printing page data). The item “double-side” represents data indicating the number of printed pages in a case where double-side printing is performed (double-side printing page data). The item “fax” represents data indicating the number of printed pages in a case where printing is performed by using a fax machine. Each of the items of the accumulated use amount data is stored in the accumulated use amount data management part 23. Based on the use history (log), the item values of the above-described items of the accumulated use amount data 33D are updated by adding the number of printed pages in correspondence with each of the process contents to the item values of the above-described items of the accumulated use amount data 33D. The updated item values of the accumulated use amount data 33D are stored as accumulated printed pages in the accumulated use amount data storage part 33. The use history (log) is generated in correspondence with the execution of a printing function (i.e. generated in units of printing jobs). Accordingly, the item values of the accumulated use amount data 33D are updated in correspondence with the execution of the printing function of the image processing apparatus 100.

Accordingly, the use limitation control part 12 can obtain the accumulated use amount corresponding to process contents by instructing the accumulated use amount data management part 23 to refer to the accumulated use amount data storage part 33.

As illustrated in FIG. 2, the use limitation control part 12 includes an upper limit setting determination part 121, a control setting determination part 122, and an application control determination part 123. As described below, the use limitation control part 12 uses the upper limit setting determination part 121, the control setting determination part 122, and the application control determination part 123 to control the applying of one or more use limitations with respect to a function requested to be executed (requested function) by the image processing apparatus 100.

The upper limit setting determination part 121 accesses the upper limit use value data storage part 31 and refers to the upper limit use value data 31D via the upper limit use value data management part 21. The upper limit setting determination part 121 determines whether there is any upper limit use value data 121 having an upper limit use value (determining the existence of upper limit use value) corresponding to the requested function.

In a case where the upper limit setting determination part 121 determines that there is a corresponding upper limit use value, the use limitation control part 12 determines that the use of the requested function is to be limited (i.e. determines that use limitation is to be performed on the requested function) and proceeds to performing a process of determining one or more control settings to be applied when executing the requested function.

In a case where the upper limit setting determination part 121 determines that there is no corresponding upper limit use value, the use limitation control part 12 determines that there is no need for the use of the requested function to be limited (i.e. determines that use limitation is not to be performed on the requested function) and proceeds to a process of executing the requested function in a regular mode (executing the requested function without any limitations).

Based on the process contents corresponding to the requested function, the control setting determination part 122 accesses the control data storage part 32 and refers to the control data 32D via the control data management part 22. The control setting determination part 122 determines whether there is any corresponding control data 32D including control settings corresponding to the process contents (determining the existence of control settings) of the requested function.

In a case where the control setting determination part 122 determines that there is corresponding control data 32D, the use limitation control part 12 determines whether the corresponding control data 32D is plural by using the control setting determination part 122. In a case where the control setting determination part 122 determines that there are no corresponding control data 32D, the use limitation control part 12 proceeds to perform a process of executing the use limitation by comparing the upper limit use value and the total accumulated use amount.

In a case where the use limitation control part 12 determines that the corresponding control data is not plural (a case of a single corresponding control setting), the application control determination part 123 determines that the corresponding control data (corresponding control setting) 32D is to be applied when executing the requested function. In a case where the use limitation control part 12 determines that there are plural corresponding control data (plural corresponding control settings) 32D, the application control determination part 123 determines which one or more of the plural corresponding control settings is to be applied when executing the requested function. In determining which one or more plural corresponding control settings is to be applied, the application control determination part 123 accesses the upper limit use value data storage part 31 and the accumulated use amount data storage part 33 and refers to the upper limit use value data 31D and the accumulated use amount data 33D via the upper limit use value data management part 21 and the accumulated use amount data management part 23.

The application control determination part 123 determines the use limitation execution conditions based on the upper limit use value data 31D and the accumulated use amount data 33D. Then, the application control determination part 123 selects (identifies) one or more control settings from the one or more corresponding control settings based on the results of the determination of the use limitation execution conditions. Then, the application control determination part 123 determines that the selected one or more control settings is to be applied when executing the requested function.

A more specific example of determining the control setting to be applied when executing the requested function is described below. In this example, process contents corresponding to the requested function is “full color printing”, the control data 32D illustrated in FIG. 5 is stored in the control data storage part 32, and the upper limit use value stored in the upper limit use value data storage part 31 is “10000”.

The application control determination part 123 determines that there are plural corresponding control data 32D (in this example, two corresponding control settings) since the control settings corresponding to management numbers 2 and 4 are valid. At this stage, a control setting that limits the full-color printing to “two-color printing in a case where the accumulated printed pages reach 20% of the upper limit printable pages” and a control setting that limits the full-color printing to “monochrome printing in a case where the accumulated printed pages reach 40% of the upper limit printable pages” are candidates to be selected as corresponding control settings to be applied when executing the requested function.

Then, the application control determination part 123 determines the use limitation execution conditions based on the upper limit use value and the accumulated use amount (in this case, accumulated printed pages). Based on the results of the determination of the use limitation execution conditions, the application control determination part 123 selects the one or more corresponding control settings (also referred to as “candidate control settings) to be applied when executing the requested function.

For example, in a case where the data stored in the accumulated use amount data storage part 33 indicates that the accumulated printed pages for color printing is [4500], the application control determination part 123 substitutes the upper limit use value [10000] and the accumulated printed pages [4500] to corresponding control settings of a conditional expression, respectively. As a result of substituting the values into the conditional expression, the conditions of the two candidate control settings are satisfied. In this case, the application control determination part 123 selects the control setting being set with a use limitation execution condition where the proportion of the accumulated printed pages is greater (higher value) than the upper limit use value. That is, among the two candidate control settings, the application control determination part 123 determines that the control setting “monochrome printing in a case where the accumulated printed pages reach 40% of the upper limit printable pages” as the control setting to be applied when executing the requested function. Thus, according to the above-described embodiment, in a case where the conditions of plural candidate control settings are satisfied, the candidate control setting having a larger threshold for determining whether to perform use limitation is selected by the application control determination part 123 as the control setting to be applied when executing the requested function.

The function process control part 13 is a function part that controls a process executed by the requested function. Based on the control setting selected by the use limitation control part 12, the function process control part 13 controls the execution of the requested function in accordance with the content of the use limitation of the control setting (in accordance with the content of the control setting to be applied). Thereby, use limitation can be performed.

The log generation part 14 is a function part that generates a use history (log) of a requested function. The log generation part 14 includes a use amount calculation part 141. The log generation part 14 generates the use history (log) and uses the use amount calculation part 141 to calculate the amount of use of the function (use amount) based on the generated use history (log). For example, in a case where the executed function is a printing function, the use amount is the number of printed pages. The log generation part 14 sends data of the calculated use amount together with the data indicating the corresponding process content to the accumulated use amount data management part 23 and instructs the accumulated use amount data management part 23 to store the sent data.

The function use control process of the image processing apparatus 100 according to the above-described embodiment of the present invention is performed by cooperatively operating the above-described function parts 11, 12, 13, 14, 21, 22, 23 of the image processing apparatus 100. It is to be noted that the following function use control process may be achieved with the above-described components and function parts of the image processing apparatus 100 by using a program (software for achieving function use control) installed in the image processing apparatus 100, so that a CPU reads the program from, for example, a HDD (Hard Disk Drive) or a ROM (Read Only Memory), loads the program to, for example, a RAM (Random Access Memory), and executes the program.

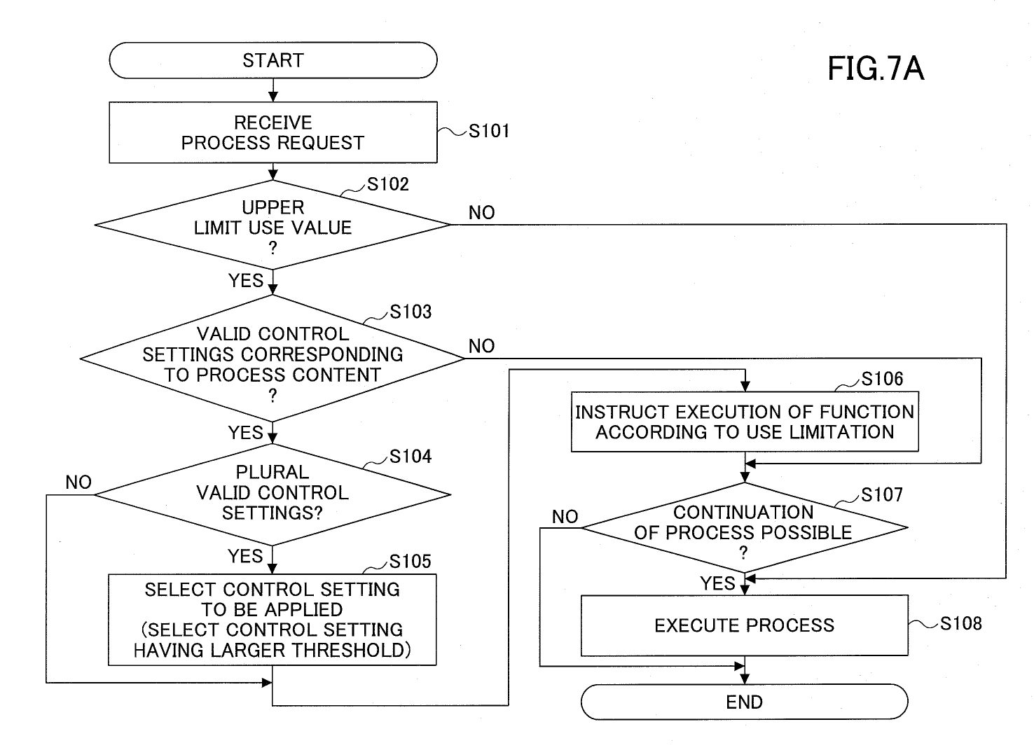

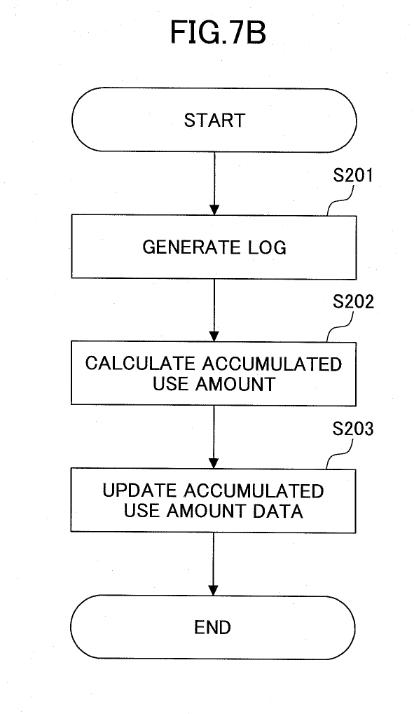

Next, an example of a function use control process performed by cooperatively operating the above-described function parts is described with reference to the flowcharts illustrated in FIGS. 7A and 7B.

FIGS. 7A and 7B are flowcharts for describing an example of a process for controlling the use of a function of an image processing apparatus 100 according to an embodiment of the present invention. FIG. 7A is a flowchart illustrating an example of a function use control operation. FIG. 7B is a flowchart illustrating an example of an accumulated use amount value recording operation.

As illustrated in FIG. 7A, the image processing apparatus 100 receives a request for execution of a function by using the process request reception part 11 (Step S101). In this step, the process request reception part 11 obtains data indicating a process content requested to be executed by a function of the image processing apparatus 100.

The image processing apparatus 100 determines whether an upper limit use value exists by using the upper limit setting determination part 121 (Step S102). In this step, the upper limit setting determination part 121 refers to the upper limit use value data 31D stored in the upper limit use value data storage part 31 via the upper limit use value data management part 21. Thereby, the upper limit setting determination part 121 can determine whether there is an upper limit use value (existence of upper limit use value) corresponding to the requested process.

In a case where the image processing apparatus 100 determines that an upper limit use value exists (Yes in Step S102), the image processing apparatus 100 determines whether there is a control setting (existence of a control setting) corresponding to the process content of the requested function exists by using the control setting determination part 122 of the use limitation control part 12 (Step S103). In this step, the control setting determination part 122 refers to the control data 32D stored in the control data storage part 32 via the control data management part 22. Thereby, the control setting determination part 122 can determine whether there is a control setting corresponding to the process content of the requested process based on the data of the process content.

In a case where the image processing apparatus 100 determines that a control setting corresponding to the process content exists (Yes in Step S103), the image processing apparatus 100 determines whether there are plural corresponding control settings by using the control setting determination part 122 (Step S104).

In a case where the image processing apparatus 100 determines that there are plural corresponding control settings (Yes in Step S104), the image processing apparatus 100 selects one or more corresponding control settings to be applied to the use limitation when the requested function is executed from the plural control settings (Step S105). In a case where the corresponding control setting is determined as not being plural (No in Step S104), the image processing apparatus 100 selects the corresponding control setting as the control setting to be applied when the requested function is executed.

In Step S105, the application control determination part 123 selects one or more corresponding control settings to be applied as follows. First, the application control determination part 123 refers to the accumulated use amount data 33D stored in the accumulated use amount data storage part 33 and obtains the accumulated use amount data 33D corresponding to a process content of the requested function based on process content data via the accumulated use amount data management part 23. Then, the application control determination part 123 substitutes the upper limit use value and the accumulated use amount to corresponding control settings of a conditional expression, respectively. Then, the application control determination part 123 selects the one or more corresponding control settings that satisfy the conditions of the conditional expression. In this step, the application control determination part 123 identifies the corresponding control settings satisfying the conditions of the conditional expression based on the results of comparing the threshold and the accumulated use amount defined in the conditional expression.

In a case where the application control determination part 123 can uniquely identify a corresponding control setting satisfying the conditions of the conditional expression, the application control determination part 123 selects the identified corresponding control setting as the control setting to be applied when executing the requested function. In a case where the application control determination part 123 cannot uniquely identify a corresponding control setting satisfying the conditions of the conditional expression (i.e. plural control settings that satisfy the conditions of the conditional expression), the application control determination part 123 selects the corresponding control setting based on comparing the thresholds of the control settings defined in the conditional expression. That is, the application control determination part 123 refers to the thresholds of the control settings defined by the conditional expression (threshold for determining whether to perform function use limitation) and selects the control setting having a larger threshold than the threshold of other control settings.

Hence, the image processing apparatus 100 according to the above-described embodiment of the present invention can limit the use of a function depending on the degree in which the use amount is accumulated with respect to the upper limit use value. In other words, the image processing apparatus 100 according to the above-described embodiment of the present invention can progressively limit the use of a function requested to be executed by the image processing apparatus 100.

The image processing apparatus 100 instructs the function process control part 13 to execute the requested function according to the use limitation content of the selected control setting by using the use limitation control part 12 (Step S106). In this step, the use limitation control part 12 sends the set value of the use limitation content of the selected control setting to the function process control part 13 and instructs the function process control part 13 to execute the requested function according to the sent set value.

The image processing apparatus 100 determines whether the process of the requested function can be continued within a predetermined limitation range by using the function process control part 13 (determining whether the content of the use limitation is “cancel printing”) (Step S107). In this step, the function process control part 13 determines whether the process of the requested function can be continued based on the set value of the use limitation content of the selected control setting.

In a case where the image processing apparatus 100 determines that the process can be continued (Yes in Step S107), the image processing apparatus 100 executes the process of the requested function according to the use limitation content by using the function process control part 13 (Step S108). In this step, the function process control part 13 reports, for example, data indicating the use limitation content applied to the requested function or data indicating the degree (phase) of the use limitation to the control panel 120 and instructs the control panel 120 to display the reported data.

Accordingly, the image processing apparatus 100 enables the user to confirm the use limitation of a function of the image processing apparatus 100 in correspondence with the accumulated use amount. Thus, the user can make the most of the function of the image processing apparatus 100 within the predetermined range of the use limitation.

In a case where the image processing apparatus 100 determines that an upper limit use value does not exists (No in Step S102), the use limitation control part 12 determines that there is no need to perform use limitation on the requested function. As a result, the image processing apparatus 100 executes the function in a regular mode by using the function process control part 13.

When there is no control setting corresponding to the process content of the requested function in a case where an upper limit use value exists (Yes in Step S102 and No in Step S103), the use limitation control part 12 determines that the use limitation is to be performed on the requested function based on the upper limit use value and the total accumulated use amount. In this step, the use limitation control part 12 refers to the accumulated use amount data 33D stored in the accumulated use amount data storage part 33 and obtains the total accumulated use amount via the accumulated use amount data management part 23 and sends data of the upper limit use value and the total accumulated use amount to the function process control part 13. Thereby, the image processing apparatus 100 determines whether the process of the requested function can be continued based on the comparison (higher/lower) between the upper limit use value and the total accumulated use amount by using the function process control part 13 (Step S107). In this step, the function process control part 13 determines that the process of the requested function cannot be continued (cancel) in a case where the total accumulated use amount has reached the upper limit use value (No in Step S107).

Next, an operation of recording accumulated use amount data 33D is described with reference to FIG. 7B. It is to be noted that the operation of recording accumulated use amount data 33D is performed in cooperation with the process of the function process control part 13 in Step S108 of FIG. 7A.

In a case where a requested function is executed, the image processing apparatus 100 generates a use history (log) of the executed function by using the function process control part 13 (Step S201).

The image processing apparatus 100 calculates the accumulated use amount resulting from the execution of the requested function (use amount when executing a job) based on the generated use history (log) by using the use amount calculation part 141 (Step S202).

The image processing apparatus 100 requests the accumulated use amount data management part 23 to update the accumulated use amount data 33D by using the log generation part 14 (Step S203). In this step, the log generation part 14 sends data indicating the calculated use amount together with data indicating the process content of the requested function to the accumulated use amount data management part 23 and instructs the sent data to be stored in the accumulated use amount data storage part 33.

[Example of Controlling Use Limitation in Accordance with Control Levels]

In the below-described example, a control level of a use limitation is incremented when the total accumulated use amount reaches the upper limit use value.

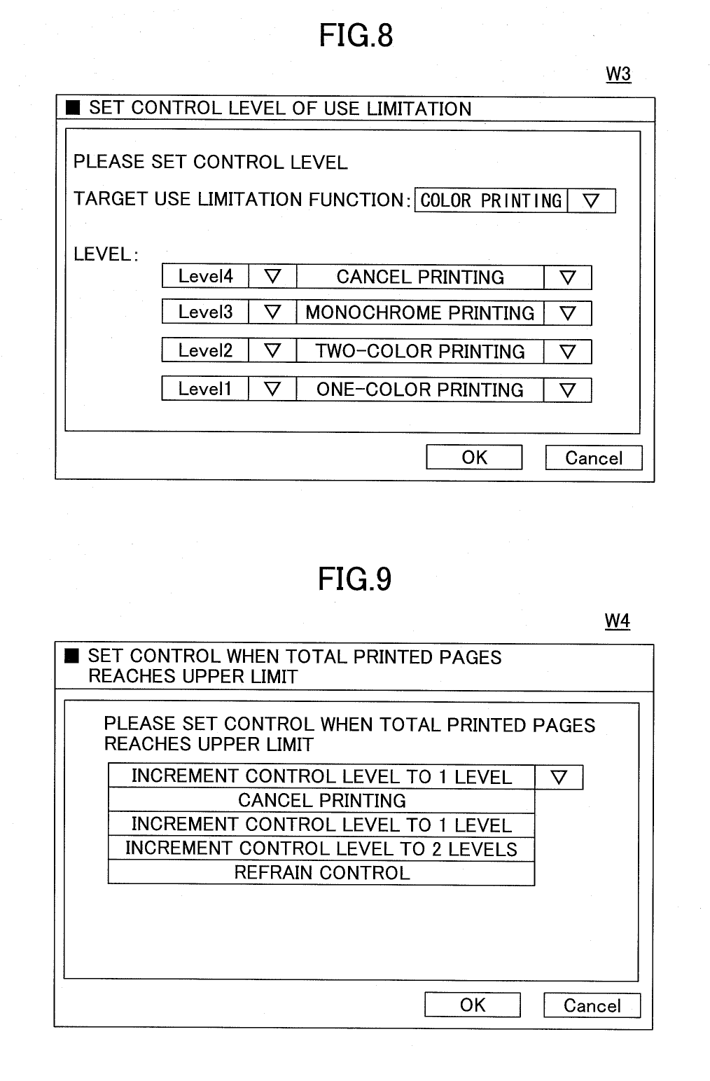

FIG. 8 is a schematic diagram illustrating an example of a setting screen W3 for setting control levels corresponding to control settings used in performing a function use limitation process according to an embodiment of the present invention. The setting screen W3 illustrated in FIG. 8 indicates a function subject to the function use limitation process (target use limitation function) and various control levels corresponding to various control settings of various processes. For example, the control data 32D that can be set with the setting screen W3 include, for example, data indicating: the content of the process of the target use limitation function selected by a pull-down menu; and combinations of the content of the use limitation (use limitation content) and the control level (level 1-4) corresponding to the selected process content. In this embodiment, by providing such an environment (setting combinations of control levels of use limitations and use limitation contents in correspondence with the target use limitation function), control levels designating the use limitation contents to be applied when executing a requested function can be set.

FIG. 9 is a schematic diagram illustrating an example of a setting screen for setting the use limitation contents when the accumulated use amount reaches an upper limit use value according to an embodiment of the present invention. With the setting screen W4 illustrated in FIG. 9, the content of use limitation when the accumulated use amount reaches the upper limit use value (upper limit printable pages) can be set. For example, the content of use limitation when the accumulated use amount reaches the upper limit use value can be set as control data 32D by selecting the items of the pull-down menu displayed on the setting screen W4. In FIG. 9, an item “increment control level one notch” is selected as the use limitation content with the setting screen W4.

In this embodiment, by providing such an environment, use limitations when reaching the upper limit use value can be set. Based on the use limitations set in such manner, the use limitation applied to the requested function can be controlled.

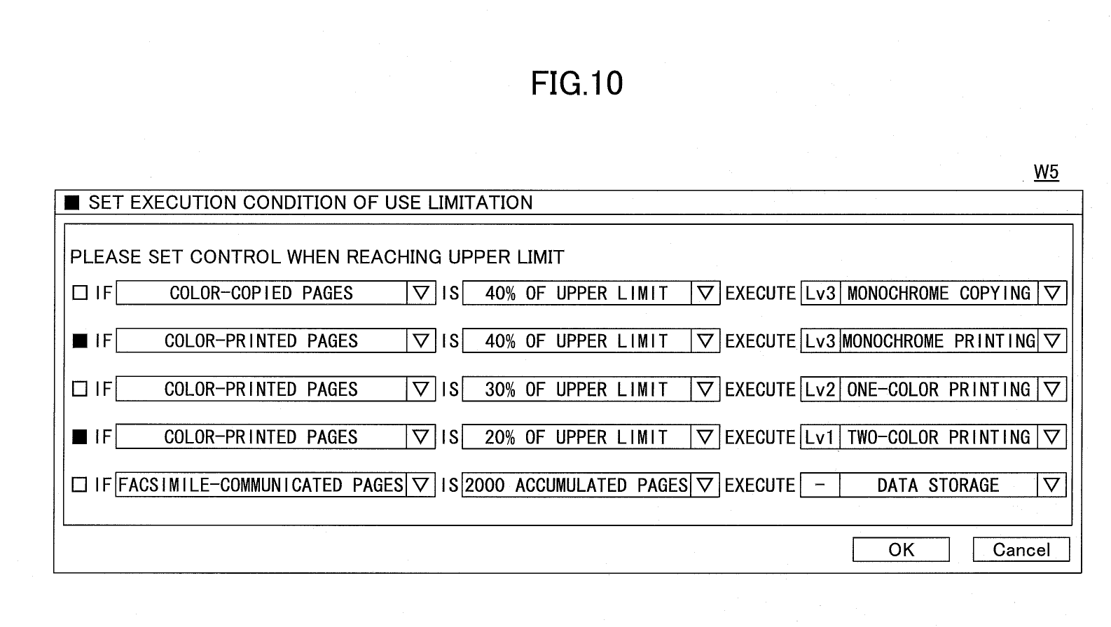

FIG. 10 is a schematic diagram illustrating another example of a setting screen W5 for setting the conditions (control rules) for executing use limitation (control data) according to an embodiment of the present invention. Similar to the setting screen W2 illustrated in FIG. 4, the setting screen W5 is for allowing, for example, the user to set the conditions for executing use limitation when an upper limit value is reached. The control data 32D that can be set with the setting screen W2 include, for example, data indicating: details (content) of a requested process (e.g., copying process, printing process, facsimile communication process) selected by combinations of pull-down menus (process content data); conditions for executing use limitation (use limitation execution conditions data) corresponding to the selected process content; and details of the use limitation assigned in correspondence with the control levels (use limitation detail data).

In this embodiment, by providing such an environment, plural control settings (corresponding to process contents assigned to different control levels) can be progressively set as control data 32D with respect to execution conditions, so that the user can determine whether to perform use limitation on a function of the image processing apparatus 100.

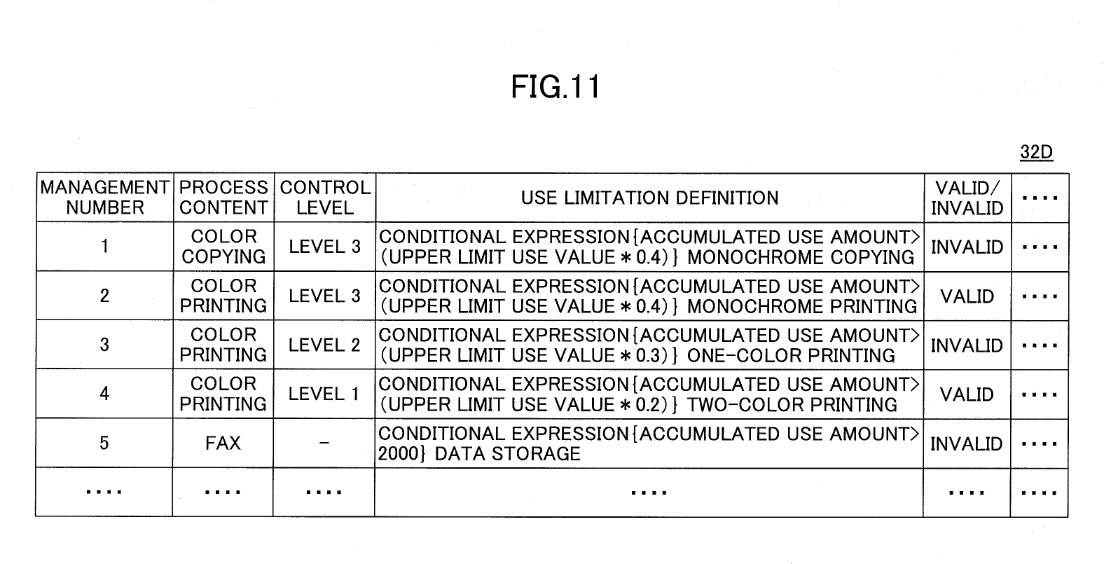

FIG. 11 illustrates an example of the data structure of the control data 32D according to another embodiment of the present invention. The contents of the control data 32D illustrated in FIG. 11 are set by using the setting screen W5 of FIG. 10. Therefore, the control data 32D of FIG. 11 includes an item “control level”. The control value assigned to the use limitation content are stored as item values in the control data storage part 32 by the control data management part 22.

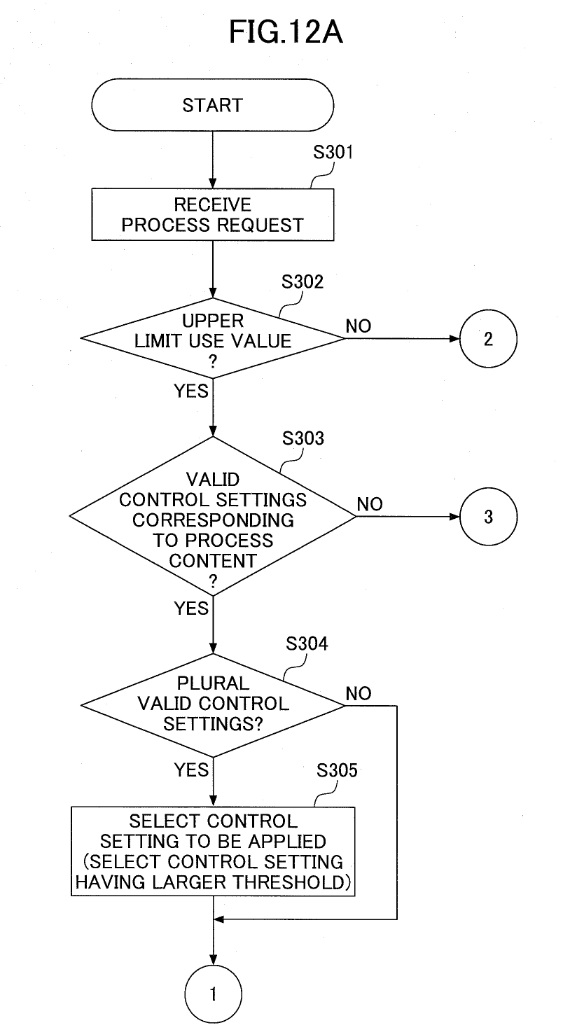

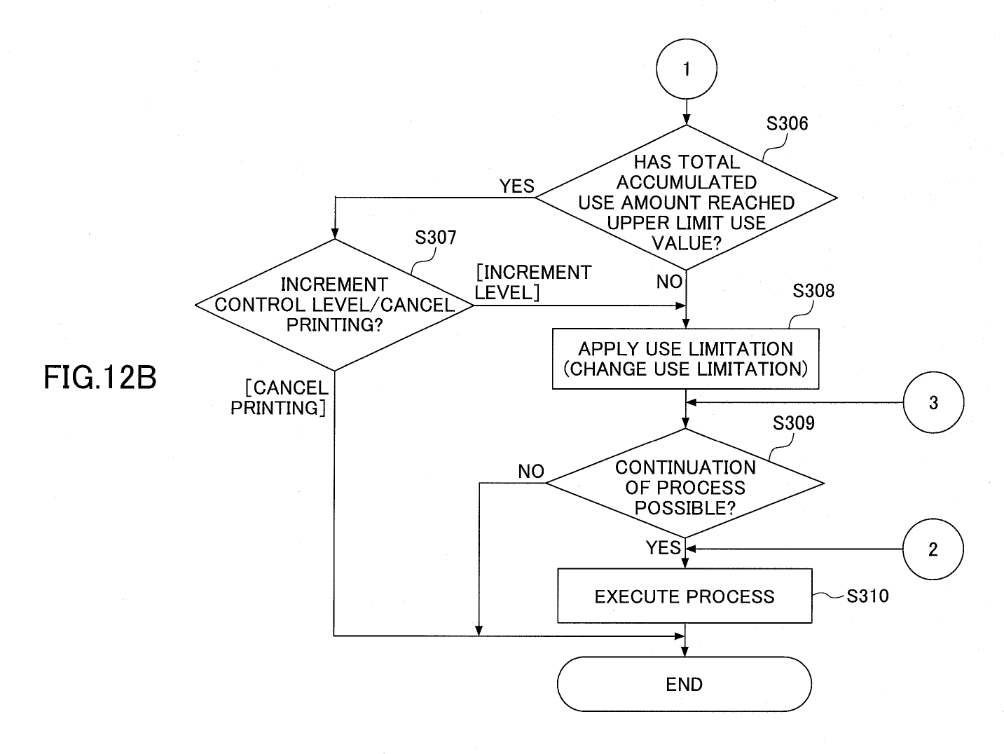

FIGS. 12A and 12B are flowcharts for describing another example of a process for controlling the use of a function of the image processing apparatus 100 according to an embodiment of the present invention. The flowcharts of FIGS. 12A and 12B illustrate a process for controlling the use of a function of the image processing apparatus 100 based on the control levels of the use limitation contents. It is to be noted that the same steps as those of the flowcharts of FIGS. 7A and 7B are not described in detail.

As illustrated in FIG. 12A, the image processing apparatus 100 receives a request for execution of a function by using the process request reception part 11 (Step S301).

The image processing apparatus 100 determines whether an upper limit use value exists by using the upper limit setting determination part 121 of the upper limit use value control part 12 (Step S302).

In a case where the image processing apparatus 100 determines that an upper limit use value exists (Yes in Step S302), the image processing apparatus 100 determines whether there is a control setting (existence of a control setting) corresponding to the process content of the requested function exists by using the control setting determination part 122 of the use limitation control part 12 (Step S303).

In a case where the image processing apparatus 100 determines that a control setting corresponding to the process content exists (Yes in Step S303), the image processing apparatus 100 determines whether there are plural corresponding control settings by using the control setting determination part 122 (Step S304).

In a case where the image processing apparatus 100 determines that there are plural corresponding control settings (Yes in Step S304), the image processing apparatus 100 selects one or more corresponding control settings to be applied to the use limitation when the requested function is executed from the plural control settings (Step S305). In a case where the corresponding control setting is determined as not being plural (No in Step S304), the image processing apparatus 100 selects the corresponding control setting as the control setting to be applied when the requested function is executed.

The image processing apparatus 100 determines whether the total accumulated use amount has reached the upper limit use value by using the use limitation control part 12 (Step S306). In this step, the use limitation control part 12 refers to the accumulated use amount data 33D stored in the accumulated use amount data storage part 33 and obtains the total accumulated use amount by using the accumulated use amount data management part 23. Accordingly, the use limitation control part 12 determines whether the total accumulated use amount has reached the upper limit use value by comparing (higher/lower level) the obtained total accumulated use amount and the upper limit use value.

In a case where the total accumulated use amount has reached the upper limit use value (Yes in Step S306), the image processing apparatus 100 determines whether the use limitation applied when the accumulated use amount reaches the upper limit use value indicates an item “increment control level” or an item “no continuation” (Step S307) by using the use restriction control part 12. In this step, the use limitation control part 12 determines whether to increment the control level or not to continue the process of the requested function based on the setting value of the control setting content when the upper limit use value is reached.

In a case where the image processing apparatus 100 determines that the control content to be applied when the total accumulated use amount has reached the upper limit use value is set as “increment control level” (Step S307), the use restriction control part 12 determines that there is a need to change the use limitation content of the selected control setting to a use limitation content assigned to an incremented (higher) control level (a control level that is incremented one or two notches).

The image processing apparatus 100 instructs the function process control part 13 to execute the requested function based on the use limitation content of the selected control setting by using the use limitation control part 12 (Step S308). In this step, in a case where the control content to be applied when the total accumulated use amount has reached the upper limit use value is “increment control level”, the use limitation control part 12 changes the use limitation content of the selected control setting to the use limitation content of an incremented control level. Accordingly, the use limitation control part 12 instructs the function process control part 13 to execute the requested function according to the changed use limitation content. For example, in a case where the control content to be applied when the total accumulated use amount has reached the upper limit use value is “increment control level one notch”, the use limitation content of the selected control setting is changed as follows. In a case where the use limitation content of the selected control setting is “one color printing” being assigned with a control level “2”, the control level “2” is incremented one notch to control level “3”. Accordingly, because the control level “3” is assigned to “monochrome printing”, the use limitation content of the selected control setting is changed to “monochrome printing”. In a case where the use limitation content of the selected control setting is “cancel printing” being assigned with the highest control level (in this example, control level “4”), the use limitation control part 12 does not change the use limitation content of the selected control setting.

Accordingly, in a case where the upper limit use value has reached the total accumulated use amount, the image processing apparatus 100 can further apply a use limitation (control setting) within a predetermined limitation range to the requested function. In other words, the image processing apparatus 100 can further progressively narrow (limit) a predetermined limitation range where the total accumulated use amount reaches an upper limit use value.

The image processing apparatus 100 determines whether the process of the requested function can be continued within a predetermined limitation range by using the function process control part 13 (determining whether the content of the use limitation is “cancel printing”) (Step S309). In a case where the image processing apparatus 100 determines that the process can be continued (Yes in Step S309), the image processing apparatus 100 executes the process of the requested function according to the use limitation content by using the function process control part 13 (Step S310). In a case where the image processing apparatus 100 determines that the process cannot be continued (No in Step S309), the image processing apparatus 100 performs a predetermined error handling process and terminates the operation by using the function process control part 13.

In a case where the control content to be applied when the total accumulated use amount reaches the upper limit use value is “refrain control”, the image processing apparatus 100 instructs the function process control part 13 to execute the requested function without changing the use limitation content of the selected control setting by using the use limitation control part 12.

Hence, the image processing apparatus 100 according to the above-described embodiment of the present invention includes a use control function for progressively limiting the use of a function of the image processing apparatus 100. With the image processing apparatus 100 according to the above-described embodiment of the present invention, the user can confirm use limitations in correspondence with the accumulated use amount and make the most of the function of the image processing apparatus 100 within a predetermined limitation range. That is, with the use control function of the image processing apparatus 100, the image processing apparatus 100 can provide an environment (platform) enabling a function of an image processing apparatus 100 to be flexibly executed progressively (step-by-step) in compliance with the user's need to use the function of the image processing apparatus 100 and the administrator's need to limit the use of the function of the image processing apparatus 100.

### Second Embodiment

Next, the following second embodiment of the present invention describes a configuration of a function use control system 1 for authenticating (permitting) a user requesting the execution of a function of an image processing apparatus and managing upper limit use value data, control data, and accumulated use amount data in correspondence with each user or each group of users. In the description and drawings of the second embodiment of the present invention, like components are denoted by like reference numerals as those of the first embodiment of the present invention and are not further described.

### <System Configuration>

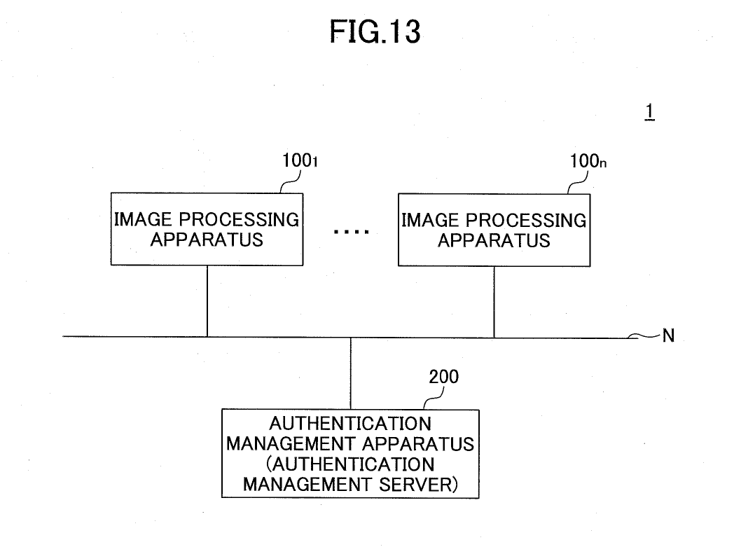

FIG. 13 is a schematic diagram illustrating a configuration of the function use control system 1 according to an embodiment of the present invention. The function use control system 1 illustrated in FIG. 13 has one or more image processing apparatuses 100₁ to 100ₙ (hereinafter also collectively referred to as “image processing apparatus 100”) and an authentication management apparatus (authentication management server) 200 that are connected by a data transmission line (e.g., network) N.

The authentication management apparatus 200 authenticates the user of, for example, the image processing apparatus 100 and/or a function of the image processing apparatus 100 and manages the authority of the user based on authentication data received by the image processing apparatus 100. The authentication management apparatus 200 may be a data processing apparatus such as a personal computer (PC).

Accordingly, the function use control system 1 having such configuration provides a function use control service based on the results of authenticating the user and confirming the authority of the user.

### <Hardware Configuration>

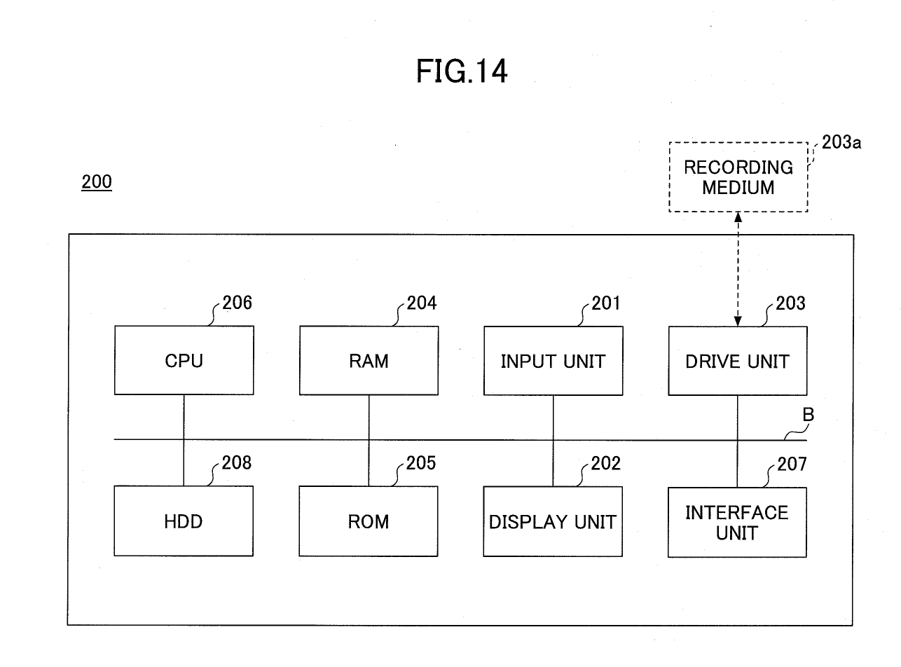

FIG. 14 is a schematic diagram illustrating a configuration of hardware parts of the authentication management apparatus 200 according to an embodiment of the present invention.

As illustrated in FIG. 14, the authentication management apparatus 200 includes, for example, an input unit 201, a display unit 202, a drive unit 203, a RAM (Random Access Memory) 204, a ROM (Read-Only Memory) 205, a CPU (Central Processing Unit) 206, an interface unit 207, and a HDD (Hard Disk Drive) 208 that are connected to each other by a bus B.

The input unit 201 includes, for example, a keyboard and/or a mouse. The input unit 20 is for inputting various control (operation) signals to the authentication management apparatus 200. The display unit 202 includes, for example, a display. The display unit 202 is for displaying process results executed by the authentication management apparatus 200.

The interface unit 207 is for connecting the authentication management apparatus 200 to the data transmission line N. Accordingly, the authentication management apparatus 200 can perform data communications with the image processing apparatus 100 via the interface unit 207.

The HDD 208 is a non-volatile storage device for storing programs and data therein. The programs and data stored in the HOD 208 in example, basic software such as an OS (Operating System, e.g., Windows (Registered Trademark), UNIX (Registered Trademark) of a data processing system that controls over the entire authentication management apparatus 200 and applications providing various functions (e.g., device management function) in the data processing system. The HDD 208 manages the stored programs and data by using a predetermined file system and/or a DB (database).

The drive apparatus 203 serves as an interface between the authentication management apparatus 200 and a detachable computer-readable recording medium 203a. Accordingly, the authentication management apparatus 200 can read data from and write (record) data to the computer-readable recording medium 203a by using the drive unit 203. The computer-readable recording medium 203a may be, for example, a Floppy Disk (Registered Trademark), a CD (Compact Disk), a DVD (Digital Versatile Disk), an SD (Secure Digital) memory card, or a USB (Universal Serial Bus) memory.

The ROM 205 is a non-volatile semiconductor memory capable of storing data even when not powered. The ROM 205 programs and data pertaining to BIOS (Basic Input/Output System) executed upon activation of the authentication management apparatus 200, data pertaining to settings of the data processing system, and data pertaining to settings of the network. The RAM is a volatile semiconductor memory capable of temporarily storing programs and data. The CPU 206 is a device that reads programs and data from, for example, the HDD 208 or the ROM 204, loads the read programs and data to the RAM 204, and executes the loaded programs and data. Thereby, the CPU 206 can control the entire authentication management apparatus 200 and achieve the functions of the authentication management apparatus 200.

With the authentication management apparatus 200 having the above-described hardware configuration, the authentication management apparatus 200 can provide various data processing services (data processing functions).

### <Use Control Function>

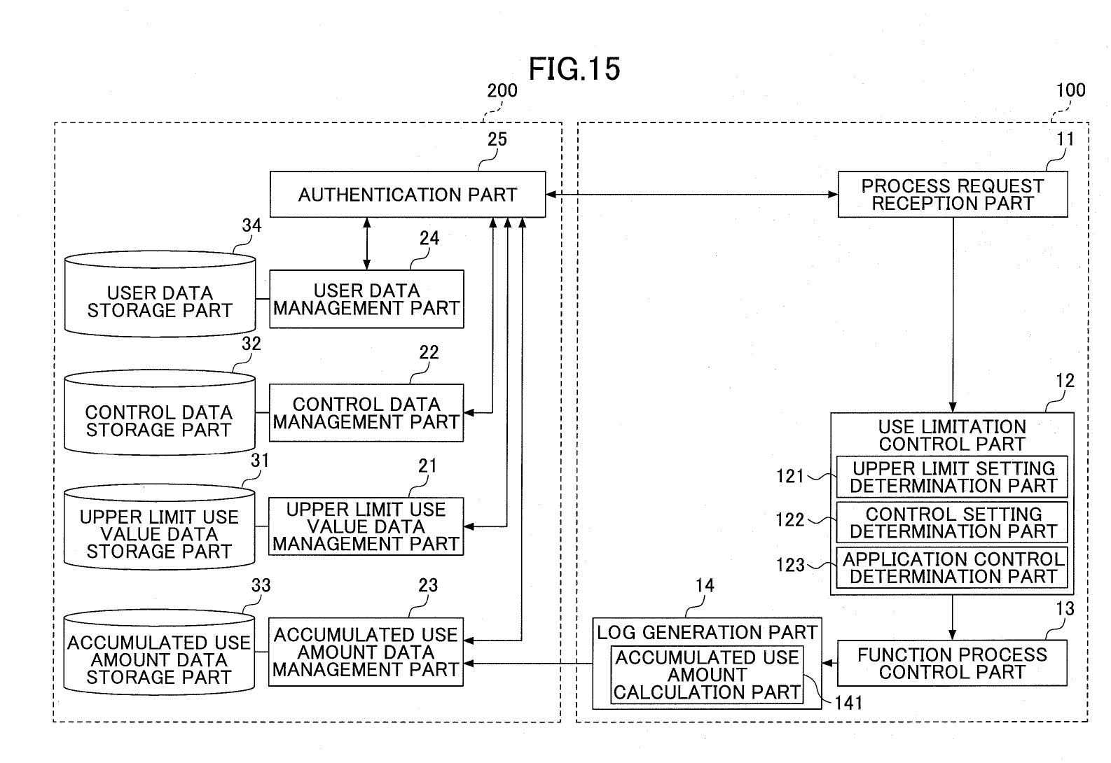

FIG. 15 is a schematic diagram illustrating function parts of the function use control system 1 according to an embodiment of the present invention. Unlike the image processing apparatus 100 of the above-described first embodiment of the present invention, the upper limit use value data management part 21, the control data management part 22, and the accumulated use amount data management part 23 are included in the authentication management apparatus 200 together with the corresponding storage parts 31, 32, 33. In addition, the authentication management apparatus 200 further includes a user data management part 24 and an authentication part 25.

In this embodiment, the authentication management apparatus 200 stores (retains) various data managed in correspondence with each user or each group of users (user units or group units), obtains necessary data (e.g., data pertaining to an upper limit use value, control settings, and accumulated use amount) from the stored data, and performs a use limitation process by using the obtained data.

Next, the various data stored in the authentication management apparatus 200 are described.

The user data management part 24 is a function part that manages data pertaining to a user or a group of the user (user data). The user data management part 24 manages the user data 340 stored in a user data storage part 34 by accessing the user data storage part 34 and manipulating (processing) the user data in accordance with instructions from, for example, the user of the image processing apparatus 100 via the authentication part 25. The manipulating (processing) of the user data includes, for example, storing of data (e.g., registering, updating), erasing (deleting) of data, obtaining (acquiring) of data, and/or referring (searching) of data.

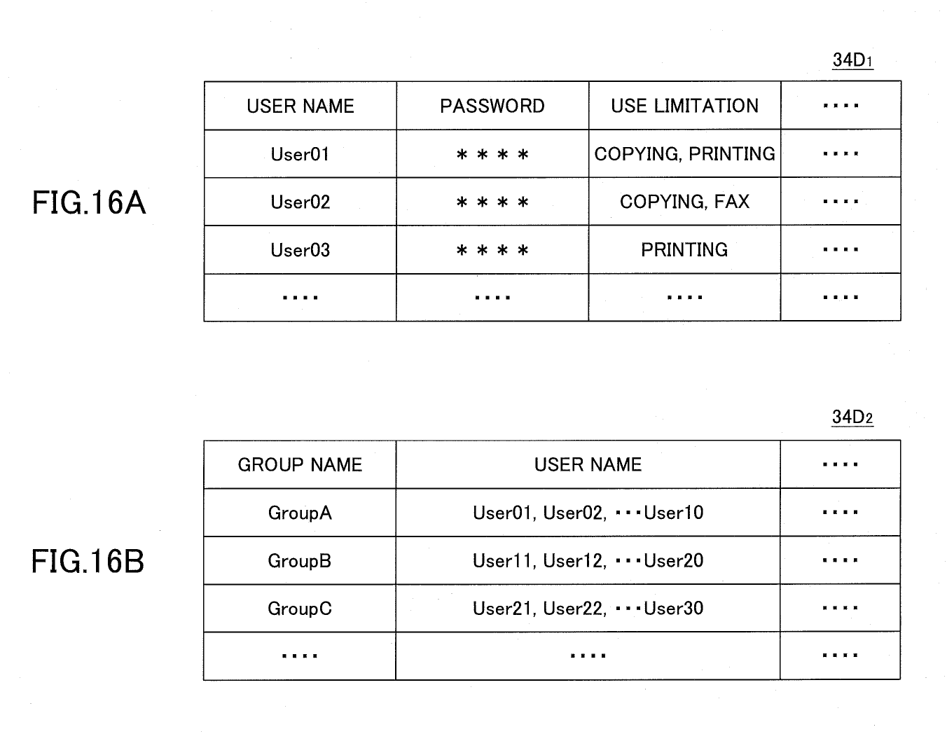

FIGS. 16A and 16B illustrate examples of data structures of user data 34D₁, 34D₂ (also collectively referred to as “user data 34D”) according to an embodiment of the present invention.

As illustrated in FIG. 16A, the user data 34D₁ includes various items such as “user name”, “password”, and “use authorization”. Item values are assigned to the items of the user data 34D₁ in correspondence with each registered user.

The item “user name” represents data that identifies a user (user identification data). The item “password” represents data for determining whether to permit the use of the image processing apparatus 100 by the user (apparatus use permission data). The item “use authorization” represents data that identifies the process in which the user is authorized to use (process use authorization data). The item value of each of the items is stored in the user data storage part 34 by the user data management part 24. For example, in a case of receiving input values via a predetermined registration setting screen (not illustrated), the user data management part 24 stores the inputs values as items values in corresponding items of the user data 34D in the user data storage part 34.

Accordingly, the authentication part 25 can obtain data indicative of authentication settings and use authorization settings corresponding to the user by instructing the user data management part 24 to refer to the user data storage part 34 based on the user identification data.

As illustrated in FIG. 16B, the user data 34D₂ includes various items such as “group name” and “user name”. Item values are assigned to the items of the user data 34D₂ in correspondence with each registered group.

The item “group name” represents data that identifies a group to which a user belongs (group identification data). The item “user name” represents data that identifies a user (user identification data).

Accordingly, the authentication part 25 can obtain data indicative of group settings of a user by instructing the user data management part 24 to refer to the user data storage part 34 based on the group identification data.

Returning to FIG. 15, the authentication part 25 is a function part that confirms the apparatus use permission and the process use authorization of a user (authentication process). In a case where the authentication part 25 receives user data (e.g., user identification data and authentication data) input by the user from the image processing apparatus 100, the authentication part 25 refers to the user data 34D stored in the user data storage part 34 via the user data management part 24. The authentication part 25 obtains authentication data (e.g., password) registered in correspondence with the user based on the received user identification data and determines whether the obtained authentication data matches the authentication data included in the input user identification data (e.g., password input by the user).

In a case where the authentication data match, the authentication part 25 determines that the user is a user permitted to use the image processing apparatus 100. In this case, the authentication management apparatus 200 reports the success of authentication (matching of authentication data) to the image processing apparatus 100 (reporting of authentication confirmation result). Accordingly, the image processing apparatus 100 display a screen indicating that the permitted (authenticated) user is permitted to request execution of a function (process) of the image processing apparatus 100. In a case where the authentication data do not match, the authentication part 25 determines that the user is a user not permitted to use the image processing apparatus 100. In this case, the authentication part 25 reports failure of authentication (authentication error) to the image processing apparatus 100.

In a case where the authentication part 25 determines that the user is permitted to use the image processing apparatus 100, the authentication part 25 obtains process use authorization data registered in correspondence with the permitted user based on the received user identification data and identifies the process (function) authorized to be used for the user. The authentication part 25 refers to the data stored in the upper limit use value data storage part 31, the control data storage part 32, and the accumulated use amount data storage part 33 via the upper limit use value data management part 21, the control data management part 22, and the accumulated use amount data management part 23 and obtains data required for performing a use limitation process based on the data indicating the process authorized to be used for the user.

Next, the upper limit use value data 31D, the control data 32D, and the accumulated use amount data 33D stored in the upper limit use value data storage part 31, the control data storage part 32, and the accumulated use amount data storage part 33 according to an embodiment of the present invention are described.

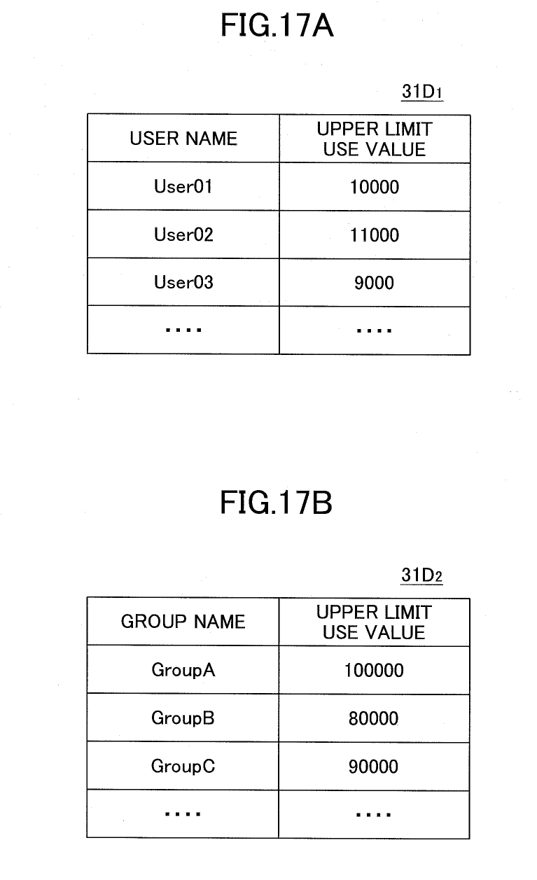

FIGS. 17A and 17B illustrate examples of data structures of upper limit use value data 31D₁, 31D₂ (also collectively referred to as “upper limit use value data 31D”) according to an embodiment of the present invention.

As illustrated in FIG. 17A, the upper limit use value data 31D₁ includes an item such as “user name”. The upper limit use value data 31D₁ include upper limit use values that are set in correspondence with each registered user. Further, as illustrated in FIG. 178, the upper limit use value data 31D₂ includes an item such as “group name”. The upper limit use value data 31D₂ include upper limit use values that are set in correspondence with each registered group.

Accordingly, the authentication part 25 can obtain the upper limit use value corresponding to the user or the group of the user by instructing the upper limit use value data management part 21 to refer to the upper limit use value data 31D stored in the upper limit value data storage part 31 based on, for example, the user identification data, the group identification data, and the process of the requested function.

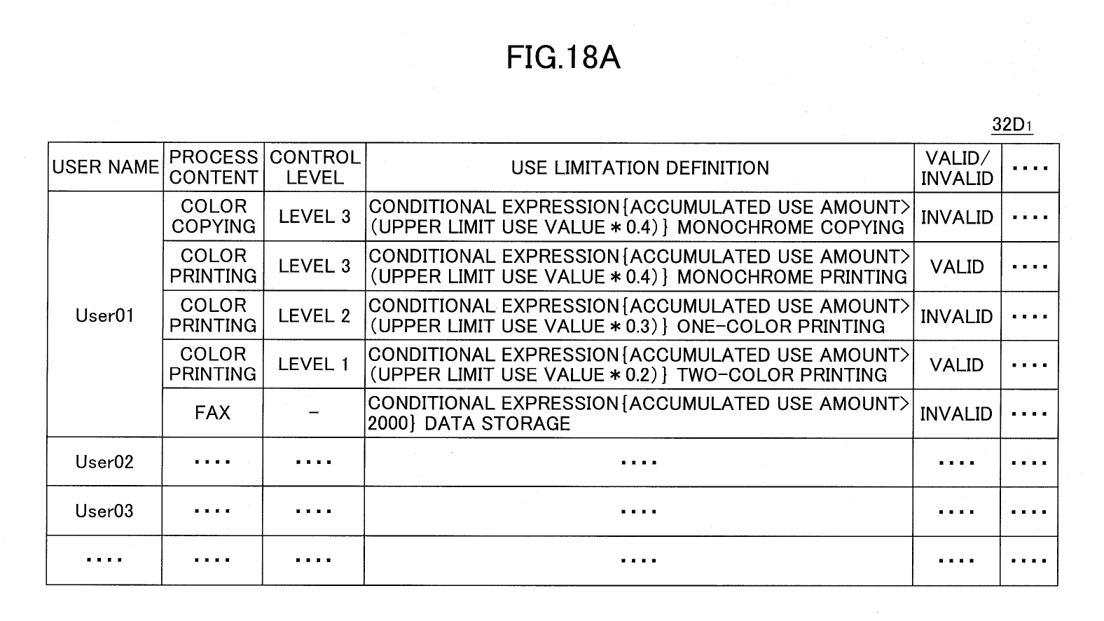

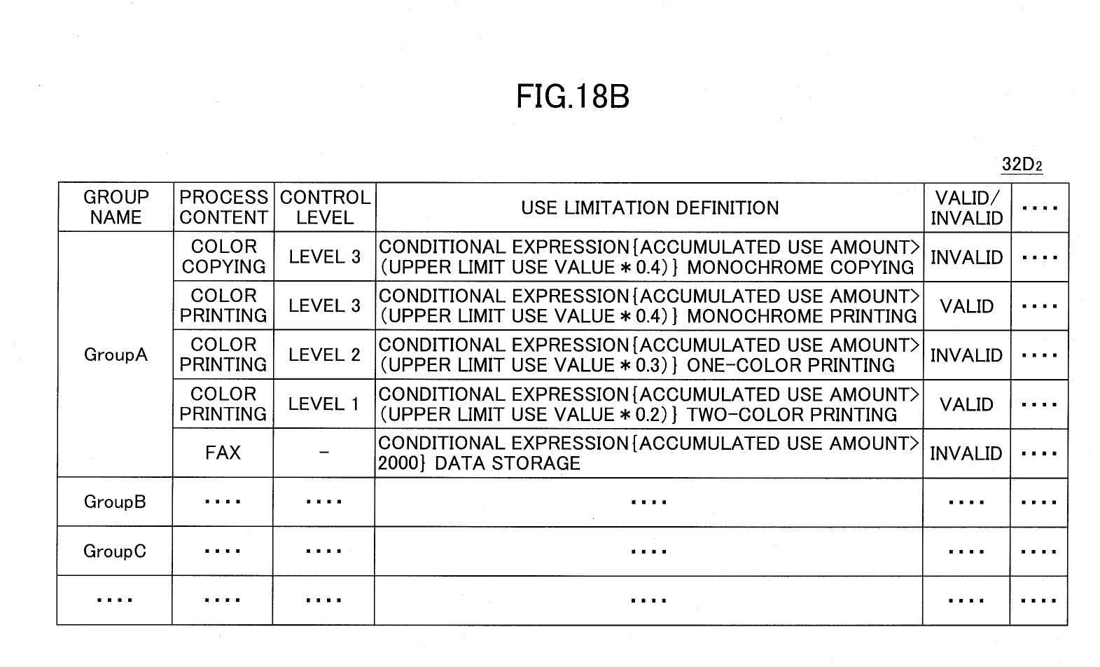

FIGS. 18A and 18B illustrate examples of data structures of control data 32D₁, 32D₂ (also collectively referred to as “control data 32D”) according to an embodiment of the present invention.

As illustrated in FIG. 18A, the control data 32D₁ includes an item such as “user name”. The control data 32D₁ include execution conditions for use limitation that are set in correspondence with each registered user. Further, as illustrated in FIG. 18B, the control data 32D₂ includes an item such as “group name”. The control data 32D₂ include execution conditions for use limitation that are set in correspondence with each registered group.

Accordingly, the authentication part 25 can obtain valid control settings corresponding to the process of the function requested by the user or the group of the user by instructing the control data management part 22 to refer to the control data 32D stored in the control data storage part 32 based on, for example, the user identification data, the group identification data, and the process of the requested function.

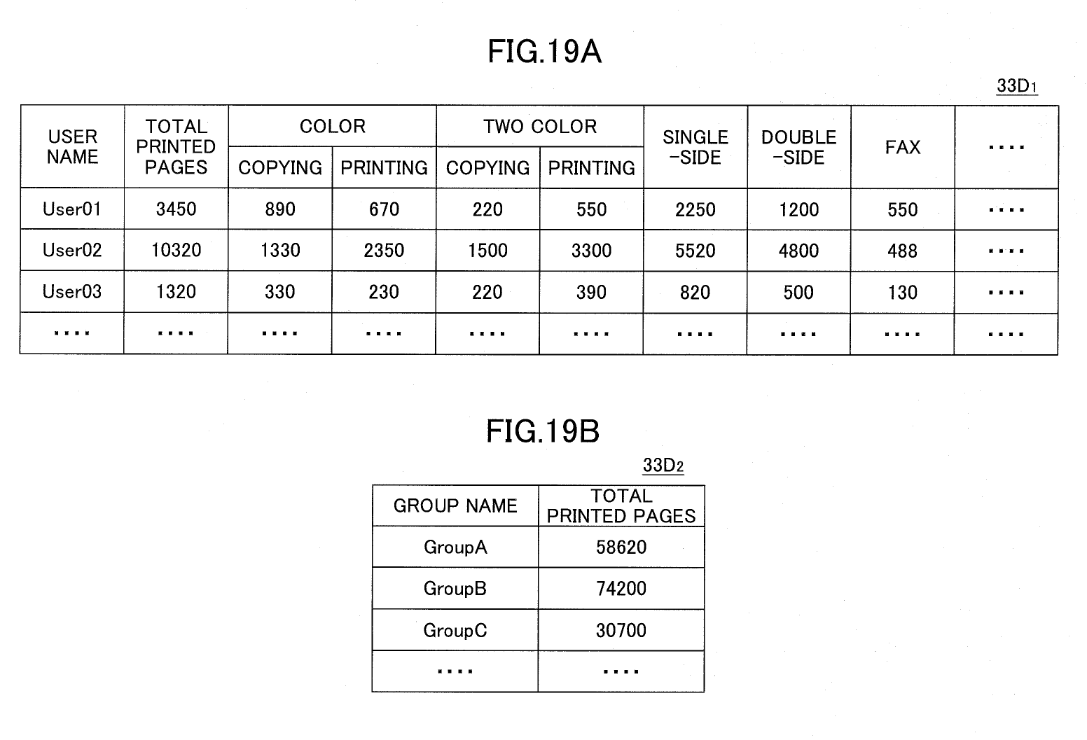

FIGS. 19A and 19B illustrate examples of data structures of accumulated use amount data 33D₁, 33D₂ (also collectively referred to as “accumulated use amount data 33D”) according to an embodiment of the present invention.

As illustrated in FIG. 19A, the accumulated use amount data 33D₁ includes an item such as “user name”. The accumulated use amount data 33D₁ include accumulated use amount recorded in correspondence with each registered user. Further, as illustrated in FIG. 19B, the accumulated use amount data 33D₂ includes an item such as “group name”. The accumulated use amount data 33D₂ include accumulated use amount recorded in correspondence with each registered group.

Accordingly, the authentication part 25 can obtain the accumulated use amount corresponding to the process of the function requested by the user or the group of the user by instructing the accumulated use amount data management part 23 to refer to the accumulated use amount data 33D stored in the accumulated use amount data storage part 33 based on, for example, the user identification data, the group identification data, and the process of the requested function.

Returning to FIG. 15, after the authentication part 25 obtains data required for performing use limitation via the above-described upper limit use value management part 21, the control data management part 22, and the accumulated use amount data management part 23, the authentication part 25 sends the obtained data to the image processing apparatus 100 together with results of the authentication process.

In this embodiment, the data required for performing use limitation is obtained in an order of from data pertaining to the permitted user and then data pertaining to the group of the permitted user. This is because the upper limit use value data 31D, the control data 32D, and the accumulated use amount data 33D, which are set in correspondence with the group of the permitted user, are required to be used only in a case where there is no data set in correspondence with the permitted user. Accordingly, in such order, the authentication part 25 obtains data required for performing use limitation stored in the above-described upper limit use value management part 21, the control data management part 22, and the accumulated use amount data management part 23 in correspondence with the permitted user or the group of the permitted user.

Accordingly, the image processing apparatus 100 uses the use limitation control part 12 to perform a use limitation process in units of the permitted user or the group of the permitted user based on the data sent from the authentication part 25.

Hence, the function use control process according to the second embodiment of the present invention is performed by cooperatively operating the above-described function parts included in the authentication management apparatus 200 and the image processing apparatus 100.

It is to be noted that the function use control process according to the second embodiment of the present invention may be achieved with the above-described components and function parts of the authentication management apparatus 200 and the image processing apparatus 100 included in the function use control system 1 by using a program (software for achieving function use control) installed in the authentication management apparatus 200 and/or the image processing apparatus 100 of the function use control system 1, so that a CPU reads the program from, for example, a HDD (Hard Disk Drive) or a ROM (Read Only Memory), loads the program to, for example, a RAM (Random Access Memory), and executes the program.

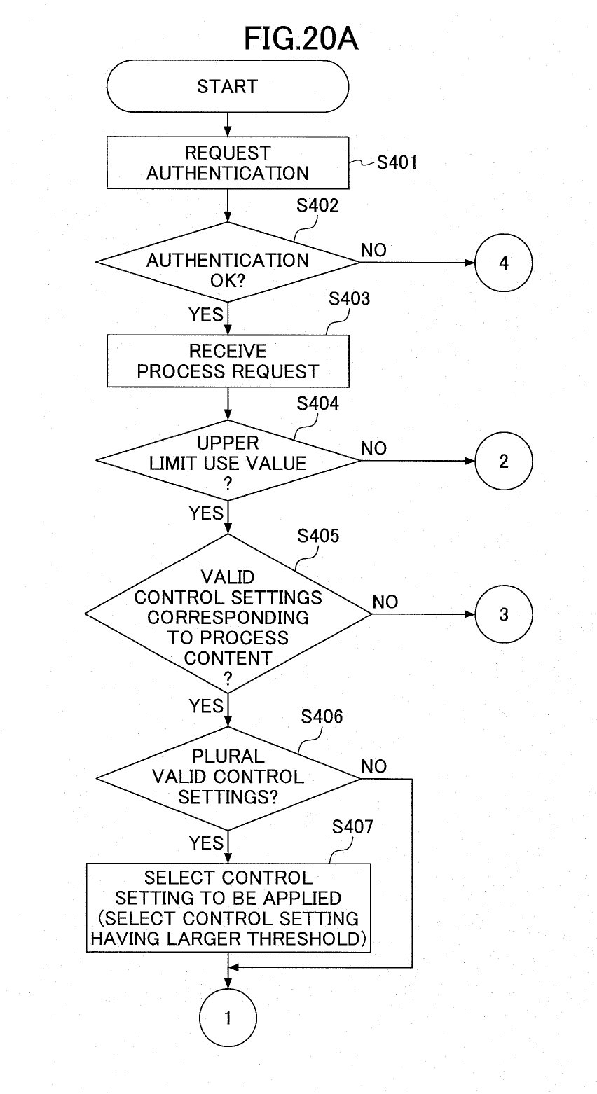

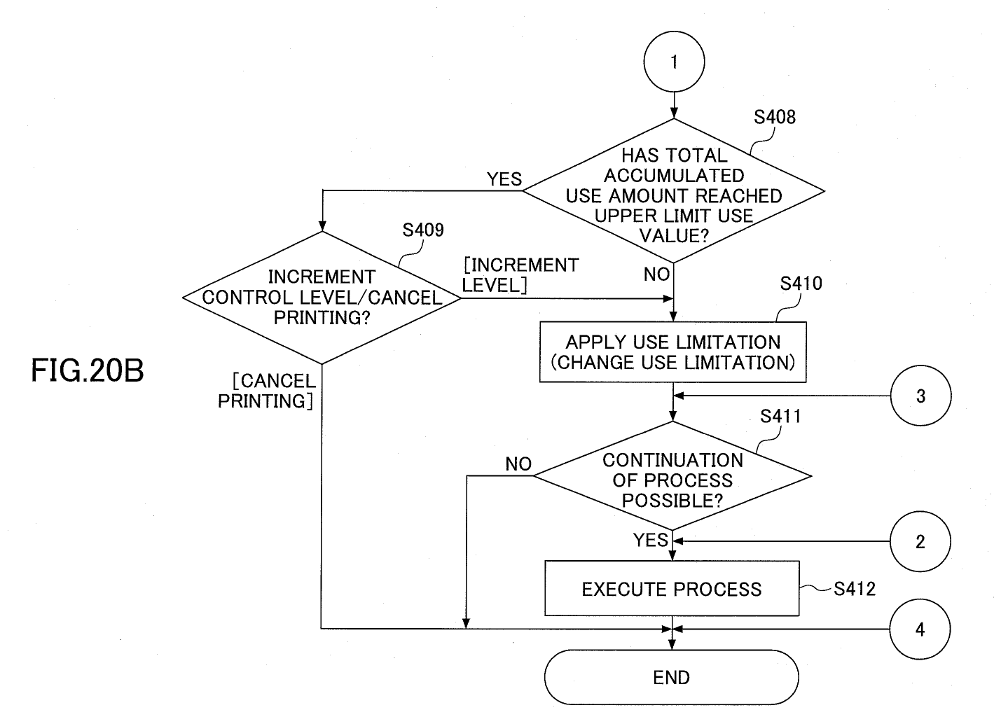

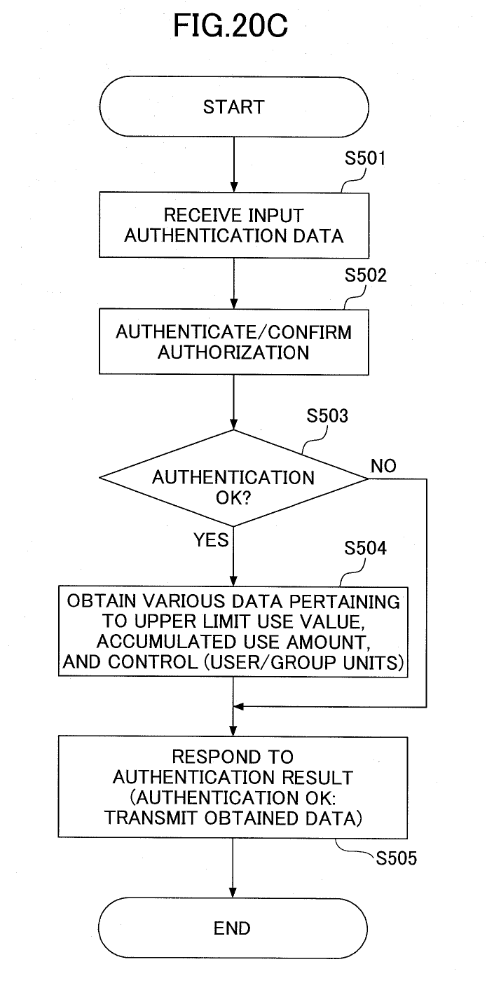

FIGS. 20A, 20B, and 20C are flowcharts for describing an example of a process for controlling the use of a function of an image processing apparatus 100 (function use control process) according to the second embodiment of the present invention. FIGS. 20A and 20B are flowcharts illustrating a part of the function use control process performed on the side of the image processing apparatus 100. FIG. 20C is a flowchart illustrating a part of the function use control process performed on the side of the authentication management apparatus 200.

As illustrated in FIGS. 20A and 20B, the image processing apparatus 100 requests the authentication management apparatus 200 to perform authentication on the user requesting execution of a function of the image processing apparatus 100 by using the process request reception part 11 (Step S401). In this step, the process request reception part 11 sends authentication data input by the user to the authentication management apparatus 200. It is to be noted that the inputting of the authentication data may be performed by receiving the user input through the control panel 120 or by receiving the user input through the external storage I/F 114. The external storage I/F 114 may be, for example, a card reader, so that authentication data can be received by reading data from the recording medium 114a such as an IC (Integrated Circuit) card).

In a case where the image processing apparatus 100 receives a report (authentication result) from the authentication management apparatus 200 that permits the user's use of the function of the image processing apparatus (authentication OK) (Yes in Step S402), the image processing apparatus 100 receives (accepts) a request to execute the function from the permitted user by using the process request receiving part 11 (Step S403). In this step, the process request receiving part 11 receives the authentication result along with the data to be used for performing the use limitation process (e.g., upper limit use value data 31D, control data 320, and accumulated use amount data 33D) which are set in correspondence with the user or the group of the user (i.e. group to which the user belongs).

In a case where the image processing apparatus 100 receives a report (authentication report) from the authentication management apparatus 200 that indicates failure of the authentication (authentication failure) (No in Step S402), the image processing apparatus 100 performs a predetermined error handling process and terminates the operation. The predetermined error handling process may be, for example, reporting displaying an authentication error to the control panel 120.

Because Steps S404 through S412 are substantially the same as those of the above-described first embodiment, detailed description of Steps S404 through S412 is omitted.

In this embodiment, however, the use control process is performed on the function requested by the permitted user with respect to the permitted user or the group of the permitted user. For example, in a case where the image processing apparatus 100 receives the data to be used for performing the use limitation process (e.g., upper limit use value data 31D, control data 32D, and accumulated use amount data 33D) corresponding to the permitted user, the image processing apparatus 100 performs the use limitation process in correspondence with each permitted user (user units). In a case where the image processing apparatus 100 receives the data to be used for performing the use limitation process (e.g., upper limit use value data 31D, control data 32D, and accumulated use amount data 33D) corresponding to the group of the permitted User, the image processing apparatus 100 performs the use limitation process in correspondence with each group of permitted users (group units).

After performing the use limitation process in correspondence with the permitted user or the group of the permitted user, the image processing apparatus 100 sends data indicating the accumulated use amount resulting from the execution of the requested function by referring to the calculation results of the log generation part 14. After receiving the data of the accumulated use amount from the image processing apparatus 100, the authentication management apparatus 200 updates the accumulated use amount data 33D corresponding to the process of the executed function by using the accumulated use amount data management part 23.

Next, an authentication process performed by the authentication part 25 of the authentication management apparatus 200 is described with reference to FIG. 20C. It is to be noted that the authentication process is cooperatively performed with the process request reception part 11 in Steps S401 and S402.

As illustrated in FIG. 20C, the authentication management part 200 receives input authentication data from the image processing apparatus 100 by using the authentication part 25.

The authentication management apparatus 200 confirms the apparatus use permission and the process use authorization of a user by using the authentication part (Step S502). The authentication part 25 confirms the apparatus use permission of the user as described below. First, the authentication part 25 refers to the user data 34D stored in the user data storage part 34 via the user data management part 24. The authentication part 25 obtains authentication data registered in correspondence with the user based on the received user identification data and determines whether the obtained authentication data matches the authentication data included in the input user identification data. In a case where the authentication data match, the authentication part 25 determines that the user is a user permitted to use the image processing apparatus 100. In a case where the authentication part 25 determines that the user is permitted to use the image processing apparatus 100, the authentication part 25 obtains process use authorization data registered in correspondence with the permitted user based on the received user identification data and identifies the process (function) authorized to be used for the user.

In a case where the authentication part 25 determines that the user is permitted to use the image processing apparatus 100 (authentication OK) and identifies the process (function) authorized to be used for the user (Yes in Step S503), the authentication part 25 refers to the data stored in the upper limit use value data storage part 31, the control data storage part 32, and the accumulated use amount data storage part 33 via the upper limit use value data management part 21, the control data management part 22, and the accumulated use amount data management part 23 and obtains data to be used for performing a use limitation process that are set in correspondence with the permitted user or the group of the permitted user (Step S504).

Then, the authentication management apparatus 200 reports the authentication result (authentication OK/authentication NG) to the image processing apparatus 100 by using the authentication part 25 (Step S505). In this step, in a case of succeeding for the authentication (authentication OK), the authentication management apparatus 200 sends the obtained data (e.g., upper limit use amount data, control data, accumulated use amount data) to be used for performing the use limitation process together with the authentication result (authentication OK) to the image processing apparatus 100.

In a case of not succeeding for the authentication (authentication failure) (No in Step S503), the authentication management apparatus 200 reports the authentication result (authentication NG) to the image processing apparatus 100 by using the authentication part 25 (Step S505).

Hence, the function use control system 1 according to the above-described embodiment of the present invention includes the image processing apparatus 100 and the authentication management apparatus 200 that cooperatively operate with each other for providing a use control function for progressively limiting the use of a function of the image processing apparatus 100.

The function use control system 1 can provide substantially the same effects as the above-described image processing apparatus 100 of the first embodiment. That is, with the function use control system 1, the user can confirm use limitations in correspondence with the accumulated use amount and make the most of the function of the image processing apparatus 100 within a predetermined limitation range. That is, with the use control function of the image processing apparatus 100 of the function use control system 1, there can be provided an environment enabling a function of an image processing apparatus 100 to be flexibly executed in compliance with the user's need to use the function of the image processing apparatus 100 and the administrator's need to limit the use of the function of the image processing apparatus 100.

### Modified Examples

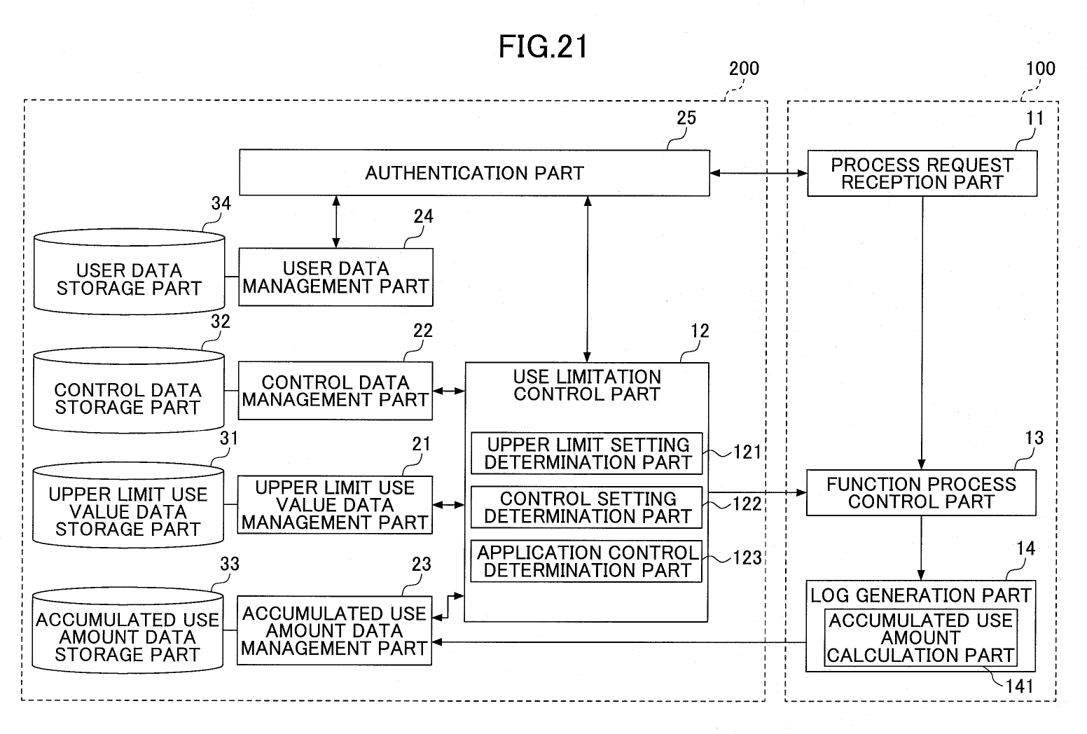

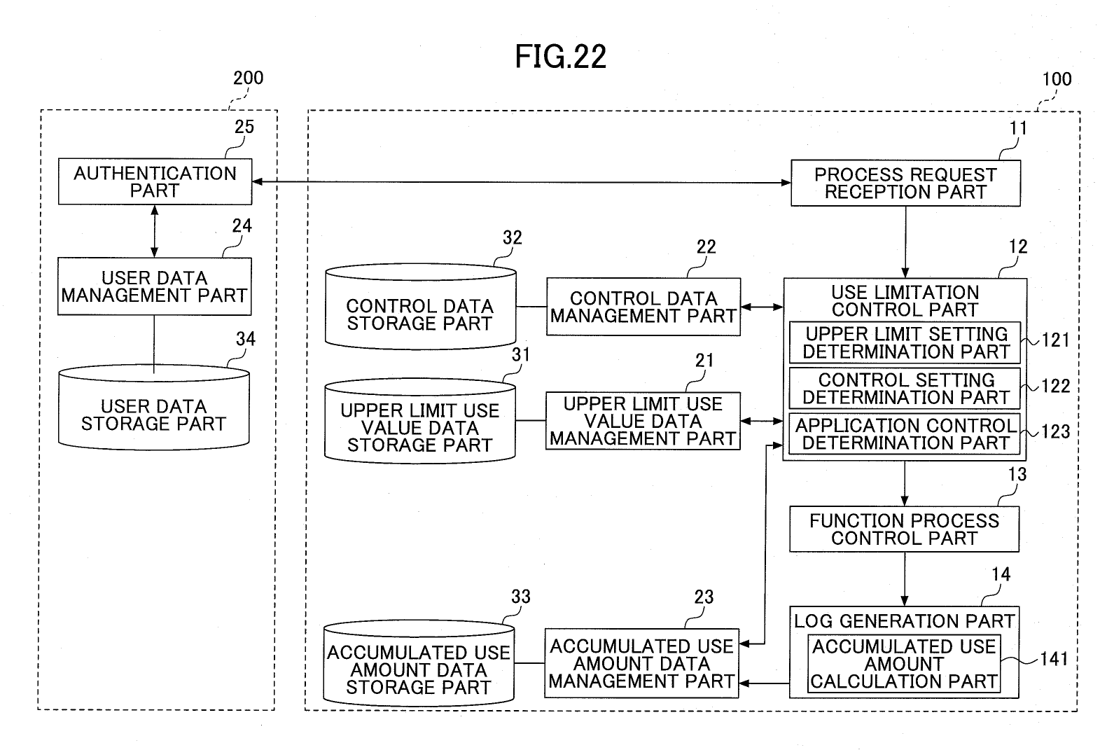

The function use control system 1, which includes the image processing apparatus 100 and the authentication management apparatus 200 cooperatively operating with each other, is not limited to the above-described embodiment. For example, as illustrated in FIGS. 21 and 22, the function use control system 1 may have a configuration illustrated in FIG. 21 or FIG. 22.

FIG. 21 is a schematic diagram illustrating a configuration of the function use control system 1 according to a first modified example. In the function use control system 1 illustrated in FIG. 21, the use limitation control part 12 is included in the authentication management apparatus 200. The authentication management apparatus 200 determines the control setting to be applied when the requested function is executed and instructs the function process control part 13 of the image processing apparatus to execute the requested function by using the use limitation control part 12.

With the configuration according to the first modified example, the authentication management apparatus 200 can perform a use control process on the image processing apparatus 100 in a batch.

FIG. 22 is a schematic diagram illustrating a configuration of the function use control system 1 according to a second modified example. In the function use control system 1 illustrated FIG. 22, the user data management part 24 and the user data storage part 34 are only included in the authentication management apparatus 200. That is, the authentication management apparatus 200 includes only an authenticating function. Accordingly, the data to be used for performing the use limitation process are not transmitted from the authentication management apparatus 200 to the image processing apparatus 100. The image processing apparatus 100 selects the control setting to be applied when the requested function is executed from the control settings corresponding to the permitted (authenticated) user or the group of the user by using the use limitation control part 12 and controls the requested function according to the use limitation of the selected control setting by using the function process control part 13.

With the configuration according to the second modified example, the amount of data communications between the image processing apparatus 100 and the authentication management apparatus 200 can be reduced. Further, a typical authentication apparatus can be used as the authentication management apparatus 200 for providing a use control function by cooperatively operating with the image processing apparatus 100.

The above-described use control function may be provided by using a processor device (e.g., CPU) that performs the above-described processes (operations) by executing a program encoded with a programming language of a suitable platform.

For example, the program may be recorded in a computer-readable recording medium 114a. Accordingly, the program can be installed in the image processing apparatus 100 via the drive unit 114. Further, because the image processing apparatus 100 is provided with the network I/F 113, the program may be downloaded from, for example, a telecommunications line and installed in the image processing apparatus 100.

The present invention is not limited to the specifically disclosed embodiments, and variations and modifications may be made without departing from the scope of the present invention.

The present application is based on Japanese Priority Application No. 2010-132936 filed on Jun. 10, 2010, the entire contents of which are hereby incorporated herein by reference.

What is claimed is:

1. An image processing apparatus comprising:
a control data storage part configured to store control data including a plurality of control settings that limit execution of a function of the image processing apparatus, the plural control settings including execution conditions that are progressively set in correspondence with one or more processes performed by the function of the image processing apparatus;
an application control determination part configured to determine one or more of the plural control settings to be applied to the function; and
a function process control part configured to limit the execution of the function by applying the one or more of the plural control settings to the function in correspondence with the progressively set execution conditions.

2. The image processing apparatus as claimed in claim 1, further comprising:
an upper limit use value data storage part configured to store upper limit use value data indicating an upper limit in which the function of the image processing apparatus can be executed;
an accumulated use amount data storage part configured to store accumulated use amount data indicating a use amount accumulated by executing the function; and
a control setting determination part configured to determine whether the plural control settings include a candidate control setting corresponding to a requested process.

3. The image processing apparatus as claimed in claim 2, wherein in a case where the candidate control setting determined to be included in the plural control settings is plural, the application control determination part is configured to determine whether the plural candidate control settings include an execution condition that is satisfied with respect to the upper limit use value data and the accumulated use amount data corresponding to the requested process;
wherein the application control determination part is configured to determine that the candidate control setting including the satisfied execution condition is to be applied to the function.

4. The image processing apparatus as claimed in claim 3,
wherein in a case where the candidate control setting determined to be applied to the function is plural, the application control determination part is configured to determine whether one of the plural candidate control settings has a threshold higher than a threshold of the other one of the plural candidate control settings,
wherein in a case where the one of the plural candidate control settings has a higher threshold than the other one of the plural candidate control settings, the application control determination part is configured to determine that the one of the plural candidate control settings is to be applied to the function.

5. The image processing apparatus as claimed in claim 4,
wherein the application control determination part is configured to obtain the threshold by multiplying a predetermined proportion with the upper limit use value,
wherein the predetermined proportion represents a proportion that the use amount has reached with respect to the upper limit use value.

6. The image processing apparatus as claimed in claim 2,
wherein the plural control settings are further stored in correspondence with a plurality of control levels,
wherein in a case where a total of the use amount reaches the upper limit value, the function process control part is configured to limit the execution of the function by applying one of the plural control levels corresponding to a control level higher than a control level corresponding to another one of the plural control levels.

7. The image processing apparatus as claimed in claim 2, wherein the plural control settings are further stored in correspondence with at least one of a plurality of users or a plurality of groups of users,
wherein the control setting determination part configured to determine whether the plural control settings include a candidate control setting corresponding to at least one of a user of a requested process or a group of users of the requested process,
wherein in a case where the plural control settings include the candidate control setting, the application control determination part is configured to determine that the candidate control setting as the one or more of the plural control settings to be applied to the function.

8. A method comprising the steps of:
a) storing control data including a plurality of control settings that limit execution of the function of the image processing apparatus, the plural control settings including execution conditions that are progressively set in correspondence with one or more processes performed by a function of an image processing apparatus;
b) determining one or more of the plural control settings to be applied to the function; and
c) limiting the execution of the function by applying the one or more of the plural control settings to the function in correspondence with the progressively set execution conditions.

9. The method as claimed in claim 8, further comprising the steps of:
d) storing upper limit use value data indicating an upper limit in which the function of the image processing apparatus can be executed;
e) storing accumulated use amount data indicating a use amount accumulated by executing the function; and
f) determining whether the plural control settings include a candidate control setting corresponding to a requested process.

10. The method as claimed in claim 9, wherein in a case where the candidate control setting determined to be included in the plural control settings in the step f) is plural, the step b) further includes determining whether the plural candidate control settings include an execution condition that is satisfied with respect to the upper limit use value data and the accumulated use amount data corresponding to the requested process;
wherein the step b) further includes determining that the candidate control setting including the satisfied execution condition is to be applied to the function.

11. The method as claimed in claim 10,
wherein in a case where the candidate control setting determined to be applied to the function in step b) is plural, the step b) further includes determining whether one of the plural candidate control settings has a threshold higher than a threshold of the other one of the plural candidate control settings,
wherein in a case where the one of the plural candidate control settings has a higher threshold than the other one of the plural candidate control settings, the step b) further includes determining that the one of the plural candidate control settings is to be applied to the function.

12. The method as claimed in claim 11,
wherein the step b) further includes obtaining the threshold by multiplying a predetermined proportion with the upper limit use value,
wherein the predetermined proportion represents a proportion that the use amount has reached with respect to the upper limit use value.

13. The method as claimed in claim 9,
wherein the plural control settings are further stored in correspondence with a plurality of control levels,
wherein in a case where a total of the use amount reaches the upper limit value, the step c) further includes limiting the execution of the function by applying one of the plural control levels corresponding to a control level higher than a control level corresponding to another one of the plural control levels.

14. The method as claimed in claim 9, wherein the plural control settings are further stored in correspondence with at least one of a plurality of users or a plurality of groups of users,
wherein the step f) further includes determining whether the plural control settings include a candidate control setting corresponding to at least one of a user of a requested process or a group of the user of the requested process,
wherein in a case where the plural control settings include the candidate control setting, the step b) further includes determining that the candidate control setting as the one or more of the plural control setting to be applied to the function.

15. A function use control system comprising:
an image processing apparatus for executing a function requested by a user; and
an authentication management apparatus including
a control data storage part configured to store control data including a plurality of control settings that limit execution of the function of the image processing apparatus, the plural control settings including execution conditions that are progressively set in correspondence with one or more processes performed by the function of the image processing apparatus and being further set in correspondence with at least one of the user or a group of users; and
an authentication part configured to perform authentication on the user and reporting a result of the authentication to the image processing apparatus;
wherein the image processing apparatus further includes
an application control determination part configured to determine one or more of the plural control settings to be applied to the function, and
a function process control part configured to limit the execution of the function by applying the one or more of the plural control settings to the function in correspondence with the progressively set execution conditions;
wherein in a case where the result of the authentication is successful, the application control determination part is configured to determine the one or more of the plural control settings to be applied to the function according to at least one of the user or the group of users.
